(19) United States
(12) Patent Application Publication
(10) Pub. No.: US 2025/0069114 A1
(43) Pub. Date: Feb. 27, 2025

(54) GENERATIVE JOURNEYS

(71) Applicants: Christopher Lintz, Franktown, CO (US); Alfredo Lainez Rodrigo, Madrid (ES)

(72) Inventors: Christopher Lintz, Franktown, CO (US); Alfredo Lainez Rodrigo, Madrid (ES)

(21) Appl. No.: 18/813,973

(22) Filed: Aug. 23, 2024

(30) Foreign Application Priority Data
Aug. 23, 2023 (ES) P202330707

(51) Int. Cl. G06Q 30/0251

(52) U.S. Cl. CPC G06Q 30/0251

(57) ABSTRACT

A computer-implemented method for generating optimized user journeys leveraging artificial intelligence is disclosed. The method includes receiving a user text prompt describing a desired journey objective and extracting context data for multiple users from a customer data platform. This context data encompasses attributes, events, predicted traits and audience memberships. A journey generation prompt is constructed by combining the received user prompt and extracted context data. This prompt is input into a machine learning model which processes the prompt to produce a user journey definition comprising interconnected nodes representing journey phases like audiences, waits and messages. The journey system validates the definition, modifying nodes to conform to predefined schema rules. The validated journey is output to campaign orchestration systems for execution across customer touchpoints. As journeys run, engagement data is collected for retraining models to improve journey performance over time.

### CROSS REFERENCE TO RELATED APPLICATIONS

This application claims the benefit of Spanish Application No. P202330707, filed on Aug. 23, 2023, which is incorporated by reference herein in its entirety.

### TECHNICAL FIELD

The disclosed subject matter relates generally to the technical field of generating customized customer engagement workflows using artificial intelligence and, in one specific example, to methods and systems for leveraging generative AI models to produce user journeys tailored to a customer's context.

### BACKGROUND

Marketing automation platforms provide tools for marketers to orchestrate personalized messaging and customer journeys. These platforms integrate with data sources like CRM systems and marketing clouds to build audiences and power customer experiences across channels. However, designing effective journeys still requires substantial manual effort and expertise.

For example, marketers must map out multi-step workflows, define complex conditional logic, and write customized messaging for each customer grouping. This process is time-consuming and challenging to optimize. As a result, many marketing journeys fail to engage customers in a truly personalized way.

Recent advances in artificial intelligence have demonstrated the ability of generative AI models to produce novel, high-quality content based on short text prompts. For example, large language models can generate everything from prose to code in a human-like way. Early applications of this technology show promise for automating tasks like content writing. However, generative AI has not yet been applied to streamline the process of mapping out personalized customer journeys

### BRIEF DESCRIPTION OF THE DRAWINGS

Some embodiments are illustrated by way of example and not limitation in the figures of the accompanying drawings.

FIG. 1 is a network diagram depicting a cloud-based SaaS system within which various example embodiments may be deployed.

FIG. 2 is a block diagram depicting example components of an example architecture of the system.

FIG. 3 is an example table that may be included in a database, such as a computer database.

FIG. 4 is a sequence diagram depicting generation of a journey.

FIG. 5 is a flowchart depicting a workflow and task workers.

FIG. 6 is an example table layout for a database, showing various columns that may be used for storing and managing data related to generative journeys.

FIG. 7 is an example schematic of primary key attributes for a database table, detailing the types and key roles of attributes that may be used for data organization and retrieval.

FIG. 8 is a sequence diagram showing example interactions between various components of the system, highlighting an example flow from journey creation to data storage.

FIG. 9 is a flowchart detailing decision-making processes and outlining subsequent actions, depending on the installation status.

FIG. 10 is a sequence diagram that outlines an example operational flow from the start of a generative journey, through various service interactions, to the final generation of journey steps.

FIG. 11 is an example view of the system architecture for managing generative journeys, illustrating the roles of various components in processing and validating journey steps.

FIG. 12 is a screenshot of a dashboard user interface for managing journeys.

FIG. 13 is a screenshot of an example access user interface.

FIG. 14 is a screenshot of an example journey creation user interface.

FIG. 15 is a screenshot of an example journey editor user interface.

FIG. 16 is a screenshot of a user interface for editing a journey flow using a natural language command within the example journey editor.

FIG. 17 is a screenshot of a user interface for editing a journey flow that includes a field for describing an audience using natural language.

FIG. 18 is a block diagram illustrating a mobile device, according to an example embodiment.

FIG. 19 is a block diagram of an example computer system on which methodologies and operations described herein may be executed, in accordance with an example embodiment.

### DETAILED DESCRIPTION

In the following description, for purposes of explanation, numerous specific details are set forth in order to provide an understanding of various embodiments of the present subject matter. It will be evident, however, to those skilled in the art that various embodiments may be practiced without these specific details.

A system, including one or more services (e.g., also referred to herein as a “Generative Service” or “Generative Journey Service”), is disclosed that allows user to generate/implement customized customer engagement workflows for their customers.

The described embodiments address several technical problems in the field of marketing automation and customer journey orchestration. For example, designing effective customer journeys requires substantial manual effort from skilled marketing professionals. Marketers must map out multi-step workflows, define complex conditional logic to route customers through different paths, and write customized messaging for each audience grouping. This process does not scale well. As the number of customer groupings and journey complexity increases, the time and expertise required grows exponentially. Marketing teams are unable to keep up with the volume and personalization required.

Another technical problem is that customer data is siloed across multiple systems like CRM, marketing automation, and/or customer data platforms. Valuable behavioral and contextual customer data lives in disparate systems and is not easily leveraged to inform journey design. Marketers must manually gather and analyze customer data from multiple sources in order to map out personalized journeys. This is time-consuming, prone to error, and results in journeys that fail to reflect the full customer context.

In addition, existing journey mapping tools do not effectively optimize journeys for high performance. There is no systematic way to validate whether a given journey will achieve marketing goals or drive customer engagement. Current tools provide limited analytics on journey effectiveness. Marketers rely on intuition and qualitative assumptions when designing journeys, leading to significant waste and lost opportunities.

Generative AI has shown promise for automating content generation, but has not been applied to the domain of customer journey mapping. For example, large language models cannot be directly leveraged to generate executable journey logic tailored to a customer's context. There are no existing techniques for prompting generative AI models to output complete, valid journey definitions personalized to a given customer grouping.

To address these technical problems, the disclosed system utilizes a generative AI model to automatically generate personalized customer journeys from plain text prompts describing the customer context and desired objectives. The disclosed system includes a journey prompt engineering framework that allows non-technical users to provide a text (e.g., natural language) prompt and receive a complete journey definition tailored to their customers.

The system includes large language models or other machine-learning model that has learned specialized knowledge about composing customer journeys using events, audiences, and channels within a defined schema. The model leverages customer data from integrated systems to ensure generated journeys reflect real-time contextual information. It is prompted using natural language, avoiding the need for users to manually map journeys and define complex logic.

The generated journeys produced by the model are executable definitions that can be directly deployed to orchestration systems and enacted across customer touchpoints. This provides significant time and cost savings compared to manual journey mapping. The system also dynamically optimizes prompts to maximize journey performance over time, using reinforcement learning on customer engagement data.

The disclosed embodiments provide a technical solution utilizing AI to solve the problems of inefficient and ineffective customer journey mapping. It automates the manual, error-prone process of journey design while still producing highly personalized journeys tailored to customer contexts. The system technically integrates disparate customer data into consumable inputs for a generative AI model. And it technically leverages AI to generate optimal journeys that drive marketing performance.

In example embodiments, the described novel innovations focus on leveraging AI advancements in generative models and reinforcement learning in a specialized framework, trained architecture and integrated data environment to solve the complex problem of customer journey mapping and optimization.

In example embodiments, generative AI is applied to automate customer journey mapping. For example, cutting-edge large language models are used to output full customer journey definitions personalized to a customer grouping described in plain text prompts.

In example embodiments, a journey prompt engineering framework is described. The system has the ability to allow non-technical users to provide natural language prompts and receive tailored journey schemas using a proprietary prompt engineering framework. This translates user prompts to consumable model inputs.

In example embodiments, a model with specialized journey mapping knowledge is used. The generative may be is specially trained on a dataset of customer journeys to learn domain conventions and schemas. This specialized knowledge allows it to reliably generate executable journey logic.

In example embodiments, disparate customer data is integrated into model inputs. For example, the framework integrates and transforms disconnected customer data from various sources into model inputs that reflect the full customer context. This data-integration powers personalization.

In example embodiments, journey performance is optimized using reinforcement learning. The system dynamically improves prompts over time using customer engagement data and reinforcement learning. This optimization of inputs to maximize outcomes is innovative.

In example embodiments, the disclosed system utilizes a robust, multi-stage computer-implemented method for generating optimized user journey definitions via an artificial intelligence-based approach.

The method commences by receiving (e.g., at an interface of the Generative Journey Service), a user text prompt describing the desired objective, outcomes or parameters for a targeted customer journey. This prompt may be provided by a marketing user through an application UI that interfaces with the Journey Service.

In example embodiments, optional steps can be expanded by separate prompts (e.g., to produce a portion of the journey). For example, a complex journey to be broken into management pieces, such that the user need not write all the natural language in one shot for a journey with many steps.

Next, the Journey Service module extracts relevant context data (e.g., from an integrated Customer Data Platform). This extracts useful context data like customer event data, profile attributes, predicted traits from predictive models, and/or audience membership data for a plurality of users. In example embodiments, these may be fetched by recency, popularity, and/or weighted context (e.g., profile attributes weighted higher than events).

The Journey Service module then dynamically constructs a rich journey generation prompt comprising both the details from the user text prompt and the extracted context data for the customer. This prompt encapsulates the inputs for the downstream AI model.

This constructed prompt is inputted into a model, which processes the prompt to produce a full user journey definition. The definition comprises an abstract syntax tree format containing interconnected nodes representing audience criteria steps, wait timer steps, messaging steps and other journey phases.

In example embodiments, rather than constructing a single prompt, streaming of steps is performed, in which each step is a portion of a journey definition. In example embodiments, the definitions can be any state-machine-based definition, such as Xstate with JSON representations of state machines, or Amazon State Machine Language (ASL). In example embodiments, each emitted step is a complete step in a state machine that may undergo validation.

After journey generation, the Journey Service performs comprehensive validation checks on the produced definition to ensure nodes comply with predefined data schema rules. Where violations occur, nodes may be modified or regenerated to conform.

Once validated, the final user journey definition is outputted to downstream Campaign Orchestration platforms which activate and execute the automated journeys at scale across customer touchpoints. In example embodiments, the journey definition may be streamed to an application (e.g., a user interface canvas). In example embodiments, the user has control on whether this journey gets published. For example, the user can edit it first, manipulate it, etc.

In example embodiments, the journey may be auto-generated. Auto generation may occur based on a determination that there is a high confidence level on the accuracy of the journey definition and the custom intentions.

As the journeys execute, the Journey Service tracks engagement data and metrics. This fuels a continuous learning loop whereby the generative models are retrained to optimize prompt engineering and journey performance over time.

In example embodiments, the Journey Service performs specialized pre-processing of the received user text prompt and extracted context data to construct an enriched journey generation prompt that serves as model input.

A Prompt Engineering module handles dynamically constructing prompts by combining the user text objective with relevant behavioral, predictive and audience data for the user (e.g., a customer). This allows injecting key contextual details into the prompt to power personalization without requiring technical users to manually provide event schemas.

The module utilizes a templatized prompt format encompassing parameters for both the user-provided objective text as well as placeholders for context data variables. A model prompt template catalog contains templates for various journey use cases. The appropriate template is selected based on initial user prompt intent detection.

Extracted data like events, attributes, audiences are dynamically inserted into the template placeholders to complete prompt construction. Appropriate transformations are applied including projecting discrete IDs into natural language descriptors so prompts are easily digestible by generative models.

The final constructed prompt thus comprises a natural language description of the user's desired journey objective combined with a profile summary of the targeted customer populated from the integrated Customer Data Platform. This rich contextual input fuels the downstream journey generation process.

The Prompt Engineering module supports dynamic injection of context details into prompts provided to generative models-enabling personalized outputs without technical user expertise.

In example embodiments, the context refers to relevant behavioral, demographic, and predictive data extracted from one or more of a plurality of customers (e.g., from an integrated Customer Data Platform (CDP)). This provides contextual inputs for powering personalized journey mapping tailored to specific customer groupings.

The Journey Service interfaces with a CDP data repository that aggregates customer data from disparate sources into a unified profile store. Data extracted includes:

Customer profile attributes: Demographic, preference, engagement metadata attributes compiled into customer profiles. Allows tailoring based on age, interests, activity levels etc.

Behavioral event data: Granular event logs of historical customer engagement across channels recorded by the system. Fuels journey personalization based on observed behaviors.

Predicted trait data: Scores outputted by external predictive models indicating likelihoods of customers exhibiting certain behaviors or outcomes. Enables anticipatory journey tailoring.

Audience data: Flags indicating membership qualifications for predefined customer audiences or clusters. Allows targeting tailored sets based on common traits.

This multidimensional extracted data encompassing profiles, behaviors, predictions and audiences represents the full context of one or more customers at a point in time. Inserting this data into journey prompts filter outputs to match the specifics of the targeted cohort.

The data is projected into easy-to-understand natural language descriptors and statistics are calculated to quantify relevant customer subsets. This structured context is injected into prompt templates to complete prompt construction for the generative model.

In this way the context powers dynamic personalized journey mapping without requiring technical expertise to manually provide data schemas.

In example embodiments, the Journey Service contains capabilities to interface with downstream orchestration and activation platforms once generated journey definitions are deployed. This includes use of platform APIs to track execution events at an aggregate level by journey to collect engagement rates, attrition metrics, and other performance indicators. Analytics dashboards provide marketers visibility into in-market journey performance.

In example embodiments, the Journey Service collects rich engagement data as journeys execute through integrated platform APIs. This includes granular event and attrition logs, conversion metrics, and behavioral indicators. A Data Feedback module handles aggregating this data from customer touchpoints and mapping events back to the associated journey deployment. The aggregated execution data fuels continuous retraining of the generative models to improve performance over time for specific journey types and use cases.

In example embodiments, the Validation module contains configurable rules mapping to various jurisdictional regulations on data usage, personalization and AI transparency requirements. Example frameworks validated against include GDPR standards, CCPA, and other emerging privacy laws. Violations trigger alerts for marketers to refine model prompts or audience criteria during journey creation.

In example embodiments, asynchronous workflows are used for managing generative journey processes, with server-side components handling real-time data streaming to optimize response times and reduce latency.

In example embodiments, the system incorporates advanced error handling and validation mechanisms, facilitated by Generative Task Workers. These workers may be used for processing journey steps, ensuring each step meets predefined criteria before being finalized. They may play a role in providing immediate feedback on errors directly on the journey canvas, allowing for quick corrections and adjustments.

In example embodiments, the system leverages a detailed context schema and journey metadata to guide the generative process. This metadata ensures that the generated journeys are not only tailored to specific user inputs but also adhere to system-wide data standards and constraints. The integration of these elements ensures that the generative journeys are both dynamic and compliant with the overarching system architecture.”

In example embodiments, a robust notification system may be used in addition to or in place of a polling system, such as a notification system employing Server-Sent Events (SSE) or WebSockets, to push updates directly to client applications. This technique not only enhances user interaction with real-time responsiveness but also alleviates the server load by reducing or eliminating frequent polling.

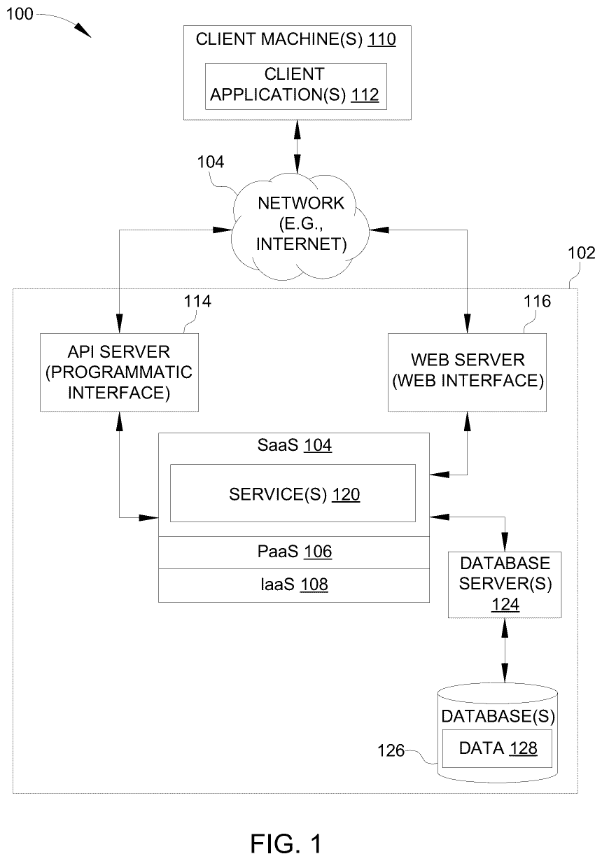

FIG. 1 is a network diagram depicting a cloud-based SaaS system within which various example embodiments may be deployed.

A networked system 102, in the example form of a cloud computing service, such as Microsoft Azure or other cloud service, provides server-side functionality, via a network 104 (e.g., the Internet or Wide Area Network (WAN)) to one or more endpoints (e.g., client machines 110). The figure illustrates client application(s) 112 on the client machines 110. Examples of client application(s) 112 may include a web browser application, such as the Internet Explorer browser developed by Microsoft Corporation of Redmond, Washington or other applications supported by an operating system of the device, such as applications supported by Windows, iOS or Android operating systems. Examples of such applications include e-mail client applications executing natively on the device, such as an Apple Mail client application executing on an iOS device, a Microsoft Outlook client application executing on a Microsoft Windows device, or a Gmail client application executing on an Android device. Examples of other such applications may include calendar applications, file sharing applications, and contact center applications. Each of the client application(s) 112 may include a software application module (e.g., a plug-in, add-in, or macro) that adds a specific service or feature to the application.

An API server 114 and a web server 116 are coupled to, and provide programmatic and web interfaces respectively to, one or more software services, which may be hosted on a software-as-a-service (SaaS) layer or platform 104. The SaaS platform may be part of a service-oriented architecture, being stacked upon a platform-as-a-service (PaaS) layer 106 which, may be, in turn, stacked upon a infrastructure-as-a-service (IaaS) layer 108 (e.g., in accordance with standards defined by the National Institute of Standards and Technology (NIST)).

While the applications (e.g., service(s)) 120 are shown in the figure to form part of the networked system 102, in alternative embodiments, the applications 120 may form part of a service that is separate and distinct from the networked system 102.

Further, while the system 100 shown in the figure employs a cloud-based architecture, various embodiments are, of course, not limited to such an architecture, and could equally well find application in a client-server, distributed, or peer-to-peer system, for example. The various server applications 120 could also be implemented as standalone software programs. Additionally, although the figure depicts machines 110 as being coupled to a single networked system 102, it will be readily apparent to one skilled in the art that client machines 110, as well as client applications 112, may be coupled to multiple networked systems, such as payment applications associated with multiple payment processors or acquiring banks (e.g., PayPal, Visa, MasterCard, and American Express).

Web applications executing on the client machine(s) 110 may access the various applications 120 via the web interface supported by the web server 116. Similarly, native applications executing on the client machine(s) 110 may access the various services and functions provided by the applications 120 via the programmatic interface provided by the API server 114. For example, the third-party applications may, utilizing information retrieved from the networked system 102, support one or more features or functions on a website hosted by the third party. The third-party website may, for example, provide one or more promotional, marketplace or payment functions that are integrated into or supported by relevant applications of the networked system 102.

The server applications 120 may be hosted on dedicated or shared server machines (not shown) that are communicatively coupled to enable communications between server machines. The server applications 120 themselves are communicatively coupled (e.g., via appropriate interfaces) to each other and to various data sources, so as to allow information to be passed between the server applications 120 and so as to allow the server applications 120 to share and access common data. The server applications 120 may furthermore access one or more databases 126 via the database servers 124. In example embodiments, various data items are stored in the database(s) 126, such as the system's data items 128. In example embodiments, the system's data items may be any of the data items described herein.

Navigation of the networked system 102 may be facilitated by one or more navigation applications. For example, a search application (as an example of a navigation application) may enable keyword searches of data items included in the one or more database(s) 126 associated with the networked system 102. A client application may allow users to access the system's data 128 (e.g., via one or more client applications). Various other navigation applications may be provided to supplement the search and browsing applications.

In example embodiments, an architecture of the system defines one or more services (e.g., Generative AI Services) configured to build prompts and access or call into large language model (LLM) providers or other artificial intelligence (AI) providers. The service may be configured to perform first-hand response validation and/or avoid attacks, like prompt injection. The services may be independent services, allowing decoupling of applications (e.g., topological data analysis (TDA) applications) from the nuances of the LLM work and provider's APIs. In this manner, LLMs or other machine-learning modules can operate autonomously as models, providers, and/or prompts evolve.

As a layer that lives between application-specific systems and LLMs, the one or more services may be reused for different use cases. In example embodiments, the system has an opinionated design that abstracts away the complexities of dealing with different providers, internal models, and/or managing prompts. It may be configured to provide a paved path to productionalize LLM-based solutions. Teams and/or modules may bootstrap their implementations with a paved-path consisting of a shared infrastructure and reusable building blocks, with such that they don't need to worry about building a serving layer and can focus on the use case at hand. The one or more services may include, for example, a shared service, a skeleton paved path, a set of libraries, and/or other subsystems.

In example embodiments, the system abstracts away providers (e.g., OpenAI providers) and/or models, including models implemented and/or provided by the system itself. In example embodiments, such abstraction makes it easy to change providers and/or models. As an example, a team working with a first model (e.g., OpenAI's gpt-4-32k) model may be able to easily change the task definition to use a different model (e.g., GCP's text-bison).

In example embodiments, the system provides a way for teams and/or separate systems to easily change and version prompts. A separate system is able to easily create new “model” artifacts containing changed system prompts without complex changes in code.

In example embodiments, the system provides a paved path to add new use cases. For example, the system may provide an opinionated set of libraries or building blocks to do common tasks, like defense against prompt injection, content moderation, validation, and so on.

In traditional ML, inference servers will normally load a model (which is a set of parameters such as neural network weights) into RAM or GPU memory, which then can be called via the framework of choice (e.g., PyTorch, TensorFlow, XGBoost). With LLMs, the concept of a model for a given task disappears in favor of a single general large language model (able to solve many tasks) together with a system and user prompt that determine what the large language model should do.

In this regard, the concept of a model artifact to serve is replaced by the particular LLM to call (e.g., given by a provider and a model identifier, such as, for example, OpenAI and gpt-4-32k) and/or the prompt to use with that model.

An LLM together with its usage details can be defined with the following schema:

```
{
  ″llm″: {
    ″provider″: ″openai″,
    ″model_id″: ″gpt-4-0613″,
    ″parameters″: {
      ″temperature″: 0.1,
      ″top_p″: 1,
      ″n″: 1,
      ″stop″: null,
      ″max_tokens″: 4092,
      ″presence_penalty″: 0,
      ″frequency_penalty″: 0,
      ″logit_bias″: null
    }
  }
}
```

With this information in the model artifact, the one or more services are able to abstract away the call to a provider via different LLMClients objects (e.g., OpenAIClient, GCPClient, etc.).

In example embodiments, the system prompt to use may be, for example, a file that could look like the following, where the task is explained to the LLM and there is a series of placeholders that are filled during inference time with information coming in the request (e.g., the customer context, which may not be known beforehand, but may be injected into the system prompt).

Example system_prompt_template.txt:

You are a marketing tool that generates user journeys from an input text describing a marketing objective. Your objective is to output a JSON definition of a user journey considering the events, traits and audiences present in a customer workspace. You will receive a user input in the form of

Initial Audience: <initial audience given by user>

Objective: <journey objective given by user>

This is how a Journey is represented:

[lengthy instructions describing journeys and audiences, etc]

This is the customer context to be referenced

{{LIST OF CUSTOMER EVENTS-ADDED DURING INFERENCE}}

{{LIST OF CUSTOMER TRAITS—ADDED DURING INFERENCE 56}

{{LIST OF CUSTOMER AUDIENCES—ADDED DURING INFERENCE}}

Similarly, the user prompt to be used could look like this, where most of all the information may be directly added from the service request:

Example user_prompt_template.txt:

Initial Audience: {{AUDIENCE DESCRIPTION-ADDED DURING INFERENCE}}

Objective: {{USER OBJECTIVE-ADDED DURING INFERENCE }}

In example embodiments, the system may store a model artifact, or servable object, in a file structure such as the following example file structure:

```
genjourneys:1.0.0/
- - - - schema.json
- - - - prompt/
- - - - - - - - - − system_prompt_template.txt
- - - - - - - - - - -user_prompt_template.txt
Where schema.json may look like the following:
{
  ″identifier″: ″genjourneys:1.0.0″,
  ″servable_type″: ″genjourneys-single-shot″,
  ″parametersllm″: {
    ″provider″: ″openai″,
    ″model_id″: ″gpt-4-0613″,
    ″llmparameters″: {
      ″provider″: ″openai″,
      ″model_id″: ″gpt-4-0613″,
      ″temperature″: 0.1,
      ″top_p″: 1,
      ″n″: 1,
      ″stop″: null,
      ″max_tokens″: 4092,
      ″presence_penalty″: 0,
      ″frequency_penalty″: 0,
      ″logit_bias″: null
    }
  }
}
```

In example embodiments, the identifier identifies the problem at hand (e.g., genjourneys or Generative Journeys) and the version of the “model” (e.g., LLM+prompt). Similarly, the servable_type determines what logic the one or more services will follow to build a prompt, call the LLM, and/or build the response. These two values may uniquely determine this logic, with the rest of elements in schema.json being dependent on the problem and servable. In example embodiments, the schema may include a single LLM information object. But the system could be configured with one or more other settings (e.g., servables types) where the problem is solved using two or more different LLM calls that may be parameterized differently.

At model artifact load-time, the one or more services may perform one or more of the following operations:
Receive a file path or identifier that uniquely identifies the servable object or model artifact to load;
Read the schema (e.g., schema.json) file for the requested model artifact;
Depending on the identifier and servable_type properties, instantiate a new ServableObject, which contains all the particular logic to solve Generative Journeys problems with one single LLM call (single-shot);
The ServableObject may create a PromptBuilder object that will read the templatized prompt files into memory;
Similarly, the ServableObject may read the LLM schema and will create an OpenAIClient object with the information necessary to call this provider and model; and/or
At the end of this process, the ServableObject is loaded into memory and ready to process requests. It contains the necessary logic to build a prompt and make a call to the LLM provider, together with all the particular business logic necessary for the Generative Journeys problem.

At request-time, the Generative Service may perform one or more of the following operations:
Receive the particular servable type to serve and any information required in a Generative Journeys service call (e.g., containing, among other information, the user context in the form of traits, audiences and events, and the user-provided free-form text with the initial audience and journey objective);
Retrieve the previously loaded ServableObject associated with the identifier genjourneys:1.0.0;
Using the associated PromptBuilder object, build the system prompt and user prompt to use with the LLM provider, replacing the templated fields with the information coming in the request;
Call the LLM provider with the loaded OpenAIClient and perform any business logic described in the ServableObject; and/or
Return the response.

With this mechanism, the system has a basic model registry functionality where model artifacts can easily be changed. Here are several example scenarios of changing a model artifact and how this would be done following this design:

1. Changing the provider. A new model artifact with a new version is created where the llm object references a different provider and model. The Generative Service layer can now just load the new artifact and will instantiate the new LLMClient object.

2. Adding a small change to the prompt. Consider the case of determining to add a new Journey step. The team experiments with a new system prompt and it changes it slightly to incorporate this new step. Now, a new model artifact with a new version is created where the system prompt file incorporates the change. Similar to the previous use-case, the Generative Service Layer can now load the new artifact and will load the new prompt.

3. Adding a new LLM call or substantially modifying the service logic. If a new LLM call is necessary (imagine we solve the problem via two LLM calls now) the team will need to create a new ServableObject where this logic is introduced, together with a new schema.json with the parameters for the two calls. A new model artifact will need to be created with a different major version and the Generative Service will need to be re-deployed to work with the new servable.

In example embodiments, generative content generation is provided on the server side. This may provide increased security—for example, API keys cannot live in client application code. Additionally, this may provide abstraction. By providing the generative AI on the server side and/or isolating it behind one or more services, the system can be decoupled from separate applications and/or from the nuances and dependency of AI APIs. This allows an AI team, modules, separate systems, and/or separate subsystems to operate autonomously with little to no impact as models, providers, and/or prompts evolve.

In example embodiments, the system may support an asynchronous generative journeys flow, such as when latencies increase (e.g., beyond a configurable latency threshold, such as a minute).

### Architecture

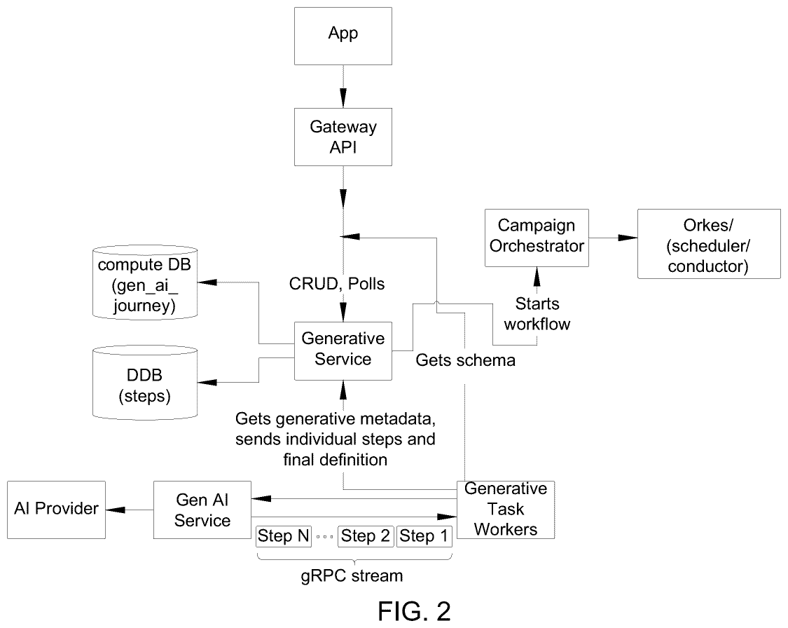

FIG. 2 is a block diagram showcasing various example components and their various example interactions within the Generative Journeys system architecture, including processes for generating and managing personalized customer journeys using generative AI technologies.

The App represents one or more client-side applications where users initiate journey generation requests. The App allows users to input specific criteria for journey generation and view the generated journey steps. The data input by users may be transmitted to the Gateway API, which may function as a conduit, routing requests from the App to the designated backend services for processing.

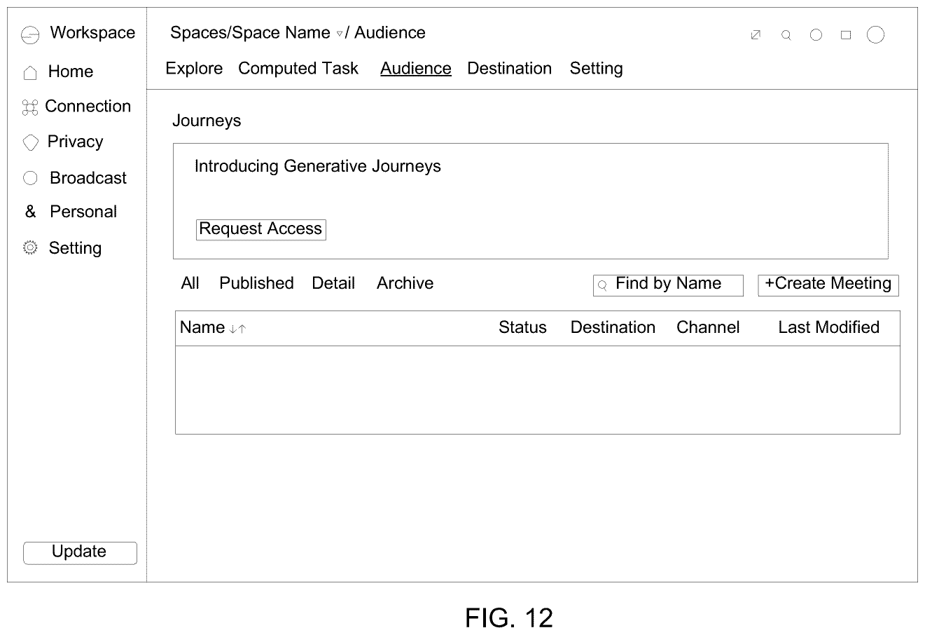

Upon receiving data from the Gateway API, the Generative Service may manage user data and handle journey requests. It may play a role in initiating the generative workflow. In example embodiments, the Generative Service creates orchestration jobs, handles the output of individual steps from Generative Task Workers, and/or responds with steps or the complete journey definition when requested. In another aspect (see, e.g., FIG. 12), rather than polling, the Generative Service can push steps to the client application. The communication from the Generative Service is facilitated through a stream, such as a gRPC stream. This stream is used for efficient, real-time data transmission, which helps manage complex data structures and/or maintain a continuous data flow. A protocol such as the gRPC protocol may be used to ensure that the data exchange between these services is not only fast but also secure, providing robust support for the system's data handling needs.

The Generative AI Service may use one or more AI models to dynamically generate one or more journey steps. It processes the input data to produce journey steps that meet predefined quality and relevance standards.

The generated journey steps may be conveyed to the Generative Task Workers through the same stream. These workers may be responsible for validating the generated journey steps. They scrutinize each step to ensure compliance with business rules and adherence to the necessary standards before allowing them to proceed further in the process.

Once validated, the journey steps may be stored in the Compute DB. This database may be specifically designed to manage and store data related to generative journeys efficiently. It may support the storage of journey definitions and ensure quick data retrieval and management, interacting seamlessly with the Generative Service to maintain data integrity and accessibility.

The Campaign Orchestrator may manage the coordination of various workflows related to campaign and journey management. It may ensure that all components function cohesively and/or manage dependencies between different workflow stages to maintain system efficiency and effectiveness.

In this architecture, each component contributes to the generative journey process: the App provides the initial user interface for data input; the Gateway API efficiently routes the data to the correct backend service; the Generative Service processes the initial data, setting the stage for generative processing; the Generative AI Service applies AI technology to create the content of the journeys, with the stream playing a vital role in ensuring efficient data flow; the Generative Task Workers validate the quality and compliance of the generated content; the Compute DB securely stores and manages the journey data; the Campaign Orchestrator oversees and coordinates the entire process, ensuring that each component performs optimally.

In example embodiments, when a Generative Journey is being “generated” and edited it is not a Journey. Thus there is no row inserted into the Journeys table. This also means it doesn't carry the same status fields (published, etc.) that a Journey does. Only once the user “saves” or “publishes” does a Generative Journey become a running Journey. When save/publish occur, the system may create a row in the Journey table with the generated and potentially user edited definition. The generative journey metadata is then related to the Journey (e.g., by foreign key).

In example embodiments, the Generative Service services Engage generative requests, including Audiences and Journeys. It may follow a separation of concerns principle by isolating the generative logic, including the control plane DB persistence. In the Journeys case, it may also abstract away reading/writing temporary steps to the database (e.g., DynamoDB_Steps Table. In example embodiments, this service does not write temporary steps to DDB; instead, it is be responsible for sending events to an event server, which pushes to the client (e.g., via SSE or Websockets).

In example embodiments, the Generative Service may be implemented as a gRPC service. By isolating generative logic behind this service, the system is configurable for a future/potential direct communication from the Gateway API to this service. Generative Service does not have to know about generative journey logic or generative control plan CRUD operations. In example embodiments, the Generative Service will translate the output of the (e.g., gRPC) response into the Output payload described herein.

The streaming steps shown in FIG. 2 provide a technological solution to several technological problems in the prior art of customer journey generation.

For example, the streaming approach addresses the issue of long wait times associated with generating entire journey definitions in one shot. For example, long wait times (e.g., 30 seconds to a minute, or longer) may have been expected for a complete journey to be generated, especially for complex journeys.

The streaming solution allows for immediate processing and/or display of journey steps on the user interface, providing real-time feedback and enabling a more interactive journey creation process.

The architecture depicted in FIG. 2 illustrates this streaming process. The Generative Service initiates the journey generation and sends individual steps to the Generative Task Workers (e.g., via a gRPC stream).

This allows for step-by-step processing and validation, rather than waiting for the entire journey to be completed before any feedback is provided.

As another example, the streaming approach enables more efficient error handling and validation. Each emitted step is a complete step in a state machine that undergoes validation.

This real-time validation allows for immediate error detection and correction, improving the overall quality and accuracy of the generated journeys.

The Generative Task Workers, as shown in FIG. 2, may also play a role in this process. They may perform detailed validations, apply business rules, and ensure that the generated journeys meet all specified requirements.

This distributed approach to validation allows for parallel processing of steps, further enhancing the system's efficiency.

As another example, the streaming solution provides a more scalable and resource-efficient approach to journey generation. Instead of processing entire journeys at once, which can be computationally intensive, the system processes and validates steps incrementally.

This approach may be particularly beneficial for complex journeys with numerous steps, as it allows for better management of system resources and improved responsiveness.

Furthermore, the streaming architecture incorporates a robust notification system that can replace or supplement the polling mechanism. By using technologies such as Server-Sent Events (SSE) or WebSockets, the system can push updates directly to client applications.

This enhances real-time responsiveness and reduces server load, addressing the inefficiencies associated with constant polling in traditional systems.

Additionally, the streaming approach enables the creation of more personalized and context-aware journeys. By processing steps incrementally, the system can dynamically adjust subsequent steps based on the validation results and context of previous steps.

This adaptive generation process allows for more nuanced and tailored customer journeys, addressing the limitations of static, pre-defined journey templates often used in prior art systems.

Thus, the streaming steps provide a technological solution that improves efficiency, scalability, error handling, and/or personalization in customer journey generation, addressing multiple technological problems inherent in traditional batch processing approaches.

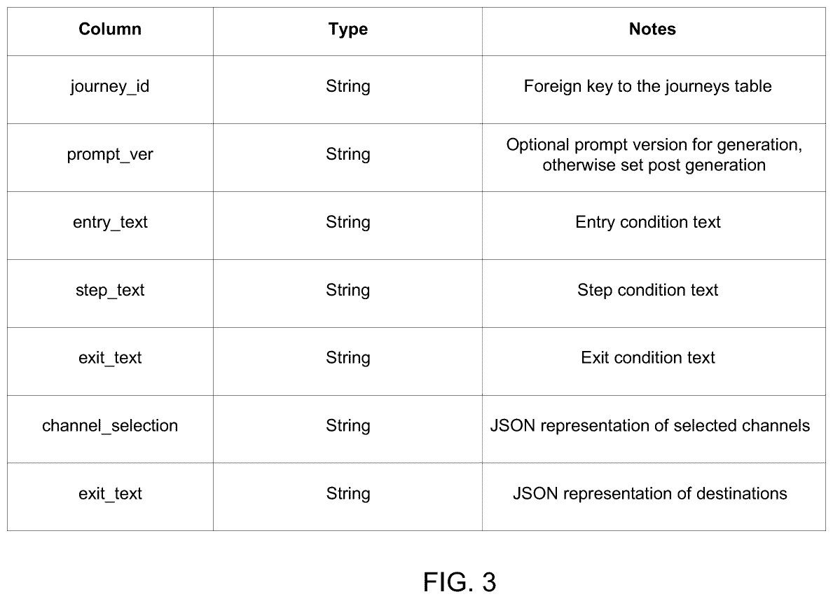

FIG. 3 is a table (e.g., “gen_ai_journey”) that may be included in a database, such as a computer database. In example embodiments, the table stores data related to generative AI journeys, including conditions, channels, and destinations. The journey_id field links it back to a journeys table to associate the data with a specific journey.

In example embodiments, the table is a component designed to store and manage data specifically related to the generative journeys within the system. This table is structured to support the efficient handling of data attributes used for operation and tracking of generative journey processes.

### Table Structure and Key Attributes:

journey_id: Stored as a string, this is a unique identifier for each journey generated within the system. It acts as a foreign key that links the generative journey data with other related data in different tables or systems, ensuring relational integrity and easy data retrieval.

prompt_ver: Also stored as a string, this attribute optionally records the version of the prompt used for generating the journey. This allows for version tracking and management, facilitating the analysis of different journey generations based on prompt iterations.

entry_text, step_text, exit_text: These string fields store textual descriptions or conditions related to the entry, steps, and exit of the journey. They encapsulate the criteria or actions defined at various stages of the journey, providing a textual blueprint of the journey's flow.

channel_selection, dest_selection: Stored as JSON strings, these fields record the selections of communication channels and destinations involved in the journey. This structured format supports complex data types and allows for flexible, detailed specification of multi-channel engagement strategies.

Additional Attributes for Enhanced Tracking and Management:

gen_input_txt: A column added as a blob type, which stores the raw input text used to generate the journey. This inclusion is valuable for auditing and debugging purposes, providing a direct snapshot of what input led to the generated journey.

prompt_version: Another column added as a varchar(64) to explicitly track the version of the generative prompt used, enhancing the system's ability to manage and analyze the evolution of journey generation strategies over time.

### Operational Role and System Integration:

In example embodiments, the “gen_ai_journey” table is not just a passive data repository but plays an active role in the generative journey lifecycle. By storing detailed, structured data about each journey, it supports the system's capabilities in monitoring, analyzing, and optimizing journey outcomes.

Integration with other system components, such as the Generative AI Service and Campaign Orchestrator, is facilitated through the structured and accessible format of the data stored in this table. This ensures that all components can efficiently query and retrieve necessary data without performance bottlenecks.

### Security and Compliance Considerations:

Given the potentially sensitive nature of the data stored (especially in user-defined texts and channel details), the table design incorporates robust security measures to protect data integrity and privacy. Compliance with relevant data protection regulations is ensured through strict access controls and encryption of sensitive data.

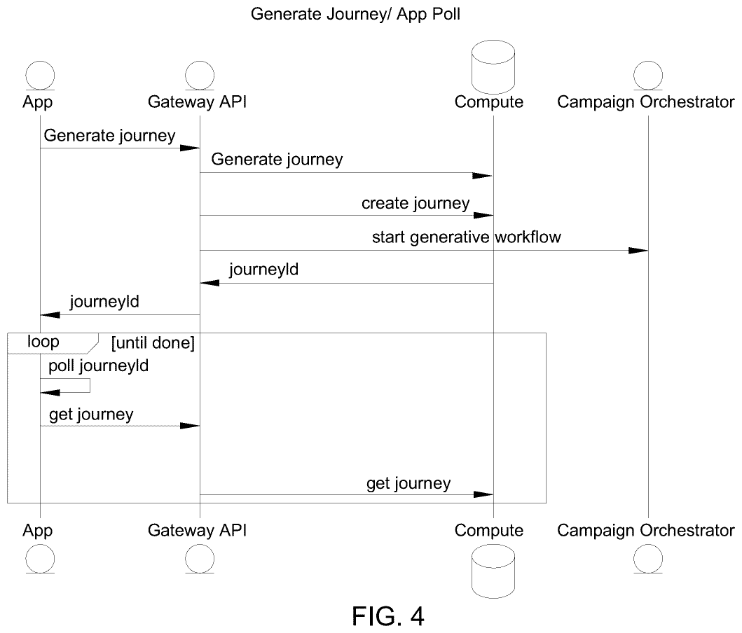

FIG. 4 is a sequence diagram depicting the generation of a journey.

In example embodiments, the App represents a client application that provides the user interface for creating journeys. After the App calls the initial generateJourney request, it may repeatedly poll to get status updates on the journey generation. This is represented by the loop in the diagram. The polling allows it to update the UI and retrieve the journey definition once ready.

The Gateway API acts as the interface between the client-side App and the server-side services like Generative Service. It handles routing the requests and responses between them. This allows the App to use a consistent interface without needing to directly call all the services.

A service, such as the Generative Service may provide the following functionality:

generateJourney: Creates a journey id and maintains name uniqueness, create journey key, store an entry in the generative ai table and relay the call to Orchestration workflow.

getGenerateJourneyUserInput: Used by the first task worker in generative orchestration workflow.

updateGenerateJourney: In case of any UI generative text edits, relay the call to Orchestration to renew the definition and update the generative/journeys table.

getJourneyProvisioningStatus: Used to poll the status on the UI. getGenerativeJourney: Internally uses getJourneyById.

Appends to the above response with the fields Journey start text, Journey step description, Journey exit condition text, Channel selection for gen journey, also generative errors to highlight on the UI along with failing nodes. updateGenerativeJourneyDefinition: Used by the generativeServiceWorkflow to update definition and provisioning status.

Once a journey_id is returned from the generateJourney request, the app may poll to get the journey (getJourneyDefinition)

The polling interval may be configurable (e.g., 4 seconds).

The Generative Service contains business logic related to journeys. When it receives the initial request, it creates a pending journey entry. This generates a journey ID which is needed for tracking status. On subsequent polls, it retrieves the current state from the Compute component using this ID.

Campaign Orchestrator: This has a responsibility for any campaign orchestration. It may support kicking off other campaign workflow jobs, like generative journeys.

Compute is a generalized term for backend services. In example embodiments, the Generative Service leverages a Compute DB to save and retrieve journey state data using the journey ID. This allows progress tracking during the asynchronous generation.

The Campaign Orchestrator kicks off the entire workflow by initiating the “Generate Journey” sequence. As the conductor, it coordinates the workflow and handles restarts for failed workflows.

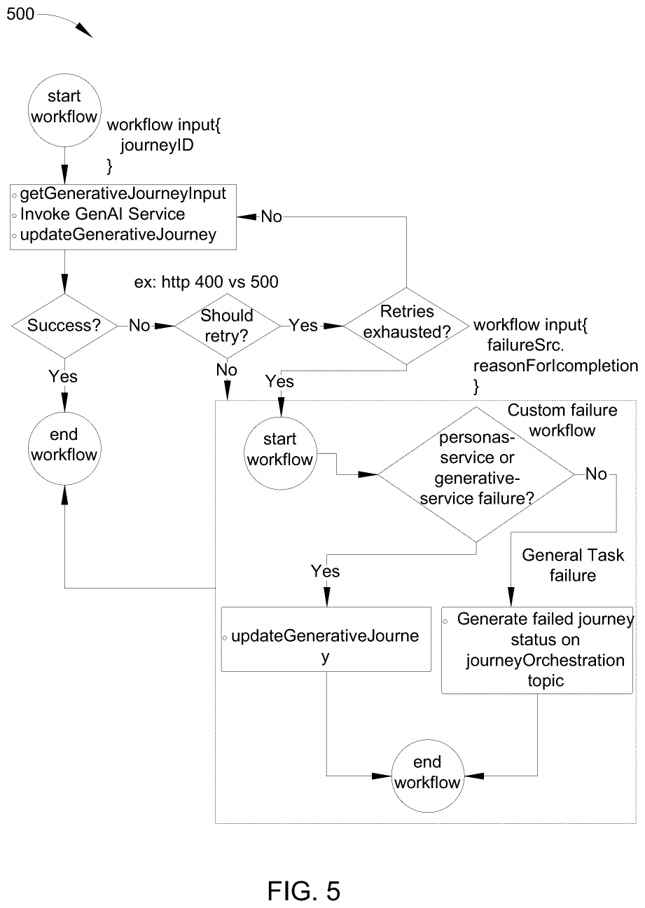

FIG. 5 is a flowchart depicting a workflow and task workers. It provides a detailed visualization of an asynchronous process to generate customer journeys leveraging AI, including the coordination logic, failure handling, and retries wrapped around the key generative steps (e.g., as an alternative to streaming of steps).

Multiple discrete task workers combine to create a robust workflow It depicts the end-to-end workflow when using generative AI to create a customer journey. The process begins when the “start workflow” step kicks off the generation workflow for a specific journey ID that needs created. This ID is used for tracking status throughout the asynchronous process.

The first major step is executing a task worker that calls the Generative AI Service, which handles constructing the AI prompt, querying the model, and validating the output journey. If this initial generation is successful, the next task worker updates the journey definition based on the AI output. At this point, if no failures have occurred, the “end workflow” step signifies completion of the successful customer journey creation.

There is also robust error handling built into the workflow. If any task worker fails during the process, the workflow first checks if retries remain to try regenerating the journey. If so, it starts over from the beginning to attempt creation again. However, if retries have been exhausted, a custom failure workflow is triggered instead. This handles categorizing the failure as either originating from the Generative Service and routes to follow-up workflows accordingly. The journey status is updated to reflect the failure state as well.

Generative AI Service: This service may be configured to handle generative requests (e.g., generative journeys requests. There may be multiple services to consume the different types of requests, or there may be a single service. From the publishing perspective, it may be treated as a single topic. RTS may utilized to limit in-flight tokens requests (e.g., to OpenAI).

The service may provide output validation (e.g., to ensure that journeys don't break a UI canvas and/or that Journeys can execute). For example, the service may validate one or more of the following:

1. The output is a valid state (e.g., xstate JSON blob) and the steps make sense and follow the Journeys schema.

2. Events, traits, and/or audiences exist in the customer space or context.

3. Definition is parse-able and valid. The system may evaluate building a subset of this validation (e.g., in Python or using the validation Go code in one or more task workers, depending on complexity).

Journeys Generation Process. The one or more services may follow a process comprising input validation, LLM generation, and/or output validation for other use cases including Generative Journeys.

Input validation. The user objective may be free-form user-provided text, and, as such, the system may be configured to be careful when operating from it. As a starting point, one or more potential validations can be performed, such as:

1. Usage Policy Validation. APIs such as OpenAI may provide a free Moderation API that can be called to control for toxic inputs (hate, harassment, violence, and so on).

2. Prompt Injection Detection. Tools like Rebuff may provide a set of features to protect LLM solutions against Prompt Injection. In example embodiments, this may be less critical for the Generative Journeys use case (e.g., when the one or more services don't have access to any external data and/or the output is not free-form text (and/or it has to comply with a strict schema)). However, an imaginative attacker could try to for instance leak part of the prompt to an email step body, so the risk is low but still existing.

As part of the input validation, the system may be configured to tokenize some or all of the system and user prompt after including the context data to see whether it is within our limits (e.g., 8k for GPT4, with the option to go up to 32k), and try to course correct if there's a solution to it.

### LLM Generation

The system may be configured to use a system prompt and/or a user prompt to call a large language model. The system prompt may include instructions about potential error conditions (e.g., asking for impossible conditions based on the context, like “for users who want to go to the moon”, or asking for things that are completely unrelated to journey creation).

The system may attempt to accomplish the goal with a zero or few-shot approach with a single LLM call to keep latency down. However, it might be the case that the system is configured to break down the task into several steps, like describing the journey first and then translating it into xstate and/or definition.

Output validation. The one or more services may be configured to perform a minimal set of validations, such as AST syntax and/or schema validation (e.g., the AST or xstate cannot reference non-existing events, traits, audiences, or non-connected steps, such as SMS), which may be independent of a future full validation. In example embodiments, the schema includes one or more events names, one or more event properties, and/or one or more profile traits key/values that make up a customer's data context or space. This data can be quite large, so various weighting or recently used algorithms may be used to generate a smaller, more relevant list to feed into an LLM prompt.

In example embodiments, the system may be configured to perform a semantic validation of the input as well, although the complexity, added latency, and lack of certainty may not warrant its inclusion in the inference path. In example embodiments, the system may be configured to run a reverse task (e.g., where the system goes from the Generated Journey to a user input and the system compares embedding similarities with the original user input). Or the system may be configured to run an LLM tasked to compare the two instruction sets.

In example embodiments, as part of the validation process, the system may be configured to perform a retry process (e.g., to repeat the LLM call with a list of errors to correct). For example, if the system has an error where a non-existing event has been used, the system may call again the LLM with an added instruction that the error should be avoided.

The system may have one or more of the following features:

Journey Trigger Prompt. Gives one or more users the ability to enter a journey trigger criteria. The one or more users could enter an existing audience, an event trigger, computed trait trigger, or something else. The system may follow what the one or more users can do right now.

An example prompt may include the following: ‘All customers that have a current prop to buy more than 0.9 & have not purchased in the last 90 days.

Journey Steps Input. One or more users may write one or more audience criteria which will trigger the start of the journey. The one or more users may also describe the journey in plain English. An example would look like this:

“For the customers who spent more than $1500, send a promotion email with a coupon. For the rest of the customers, just send out a promotion email without the coupon” and/or

“Wait 5 days, check if each branch opened the email. If they did, remove them from the campaign, but if they did not, then resend a second version of the same email.”

Channel Selection. Gives one or more users the ability to select (e.g., not with text prompt) one or more specific channels that a marketer could use for this marketing campaign.

Types of journeys may include product-based journeys, such as emails with one featured product, trending products, new stock/new product(s), similar products that users loved, About product/Customer Story, and/or abandoned cart.

In example embodiments, the Generative Journeys Service handles business logic related to creating journeys. The Generative Service maintains a simpler role of providing access to context schema. The App leverages the Gateway API to route requests to the Generative Journey Service.

A key enhancement is the bidirectional data flow between the Gateway API and Event Service. This is facilitated by a technology such as GraphQL subscriptions over websockets, allowing real-time streams of events to power journey context and personalization. The Event Service publishes context-specific events, which the Gateway API consumes only for relevant contexts.

The new Generative Consumer pools requests for the Generative AI Service, which focuses solely on interfacing with AI models. This allows better scale and performance. Load is balanced across consumers via Redis.

Output validation has been shifted to the Campaigns API, enforcing journey schema rules. This brings focus to the specialized validation logic. The Compute Interfaces handle lower-level validation.

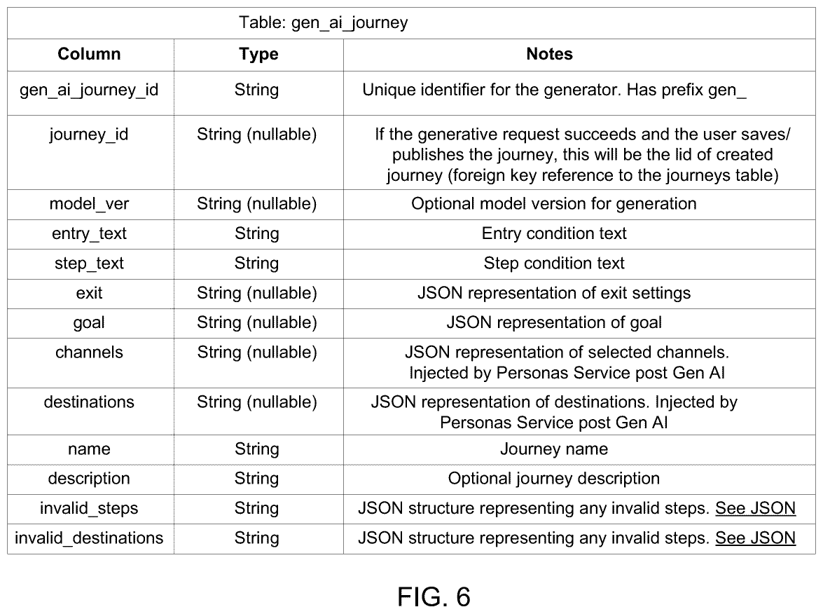

FIG. 6 depicts an example database table (e.g., “gen_ai_journey”) that is designed to store comprehensive data about each generative journey. A table like this may be used for managing the lifecycle of journeys, from creation through to potential publication, and may play a role in data analytics and system optimization.

The table may be structured with one or more of the following described attributes to capture a wide array of information about each journey. The primary key, gen_ai_journey_id, uniquely identifies each record, ensuring precise referencing and retrieval. The journey_id field, which can be null until a journey is finalized, links generative journey entries to actual journey records in the main journeys table, facilitating relational integrity and complex queries. The model_ver attribute tracks the version of the AI model used, critical for analyzing the impact of model updates on journey outcomes.

Textual descriptions of the journey's flow may be captured in entry_text, step_text, and exit_text fields, detailing the entry criteria, the steps involved, and the exit conditions, respectively. These fields may be used for reconstructing the journey logic during reviews or audits. The channels and destinations fields, which may be stored as nullable JSON strings, provide detailed specifications of the engagement strategies employed, accommodating complex multi-channel interactions.

Additional attributes such as name and description offer contextual metadata about the journey, aiding users in managing and distinguishing between multiple journeys. The fields invalid_steps and invalid_destinations, which may be formatted as JSON structures, document any issues or errors identified during journey validation, which are essential for debugging and refining journey designs.

The operational role of the “gen_ai_journey” table extends beyond mere data storage. It underpins the system's capability to monitor, analyze, and/or optimize journey outcomes, ensuring data integrity and supporting advanced analytics. Integrated seamlessly with other system components like the Generative AI Service and Campaign Orchestrator, the table supports efficient data interactions and retrieval, facilitating dynamic system responses and informed decision-making.

One or more security or compliance techniques may be implemented, given the potential sensitivity of the data stored. The table's design incorporates robust security measures such as stringent access controls and data encryption to safeguard data integrity and privacy. Compliance with relevant data protection regulations ensures adherence to legal standards, maintaining the system's reliability and trustworthiness.

In summary, this table may be a provide a comprehensive structure and multifaceted role within the Generative Journeys system. It not only serves as a data repository but also enhances the system's functionality through detailed data management, robust security practices, and/or seamless integration with other system components. This ensures that the Generative Journeys system remains efficient, secure, and capable of delivering optimized personalized customer journeys.

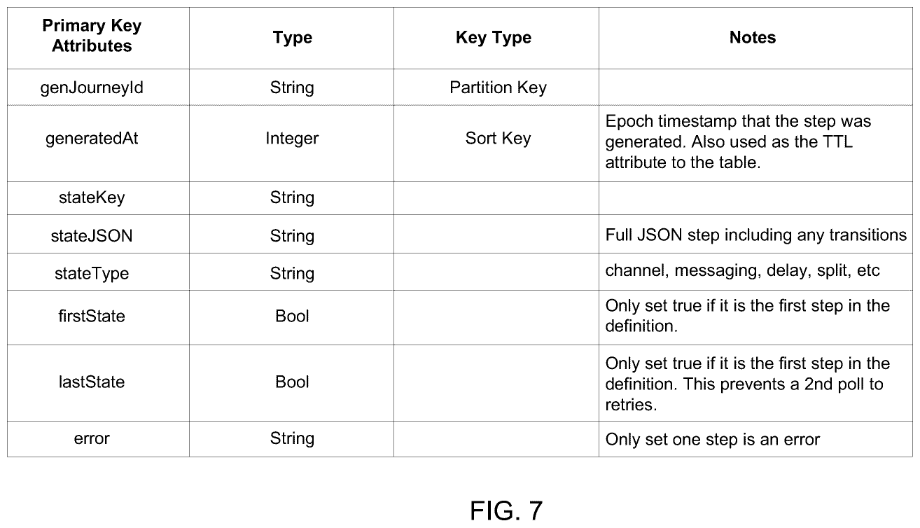

FIG. 7 is an example table that includes an in-depth view of the primary key attributes and their configurations within the “gen_ai_journey” table of FIG. 6. This table is designed to efficiently manage and store detailed data about each generative journey, facilitating robust data handling and supporting the system's advanced functionalities.

The table's design includes one or more primary key attributes that ensure data integrity and facilitate efficient data retrieval and management. For example, the genJourneyId may serve as the partition key and a unique identifier for each generative journey, ensuring that each entry can be distinctly accessed and managed. The generatedAt attribute, used as the sort key, records the epoch timestamp when each journey step was generated. This timestamp is also utilized as the Time to Live (TTL) attribute for the table, which helps in managing the lifecycle of the data by automatically removing outdated entries.

Additional attributes in the table include stateKey and stateJSON, which store the state of each journey step in JSON format, including any transitions that occur during the journey. These attributes may be used for reconstructing the journey's flow and for debugging purposes. The stateType attribute categorizes the state by its function, such as messaging, delay, or split, providing further context about each step's role within the journey.

The table also includes attributes like firstState and lastState, which are Boolean flags indicating whether a step is the first or the last in the journey definition. These flags may be used for managing the flow of the journey, ensuring that the system correctly handles the initiation and conclusion of each journey. The error attribute may be used to record any errors that occur during a step, providing a mechanism for error tracking and resolution.

Security and compliance considerations are deeply embedded in the table's architecture. Data encryption and strict access controls protect sensitive data and ensure that the system adheres to relevant data protection regulations. This approach not only safeguards the data but also builds trust with users by maintaining high standards of data security and privacy.

By providing a structured and secure environment for data management, the table enhances the system's functionality and ensures that it can deliver high-performance, personalized customer journeys.

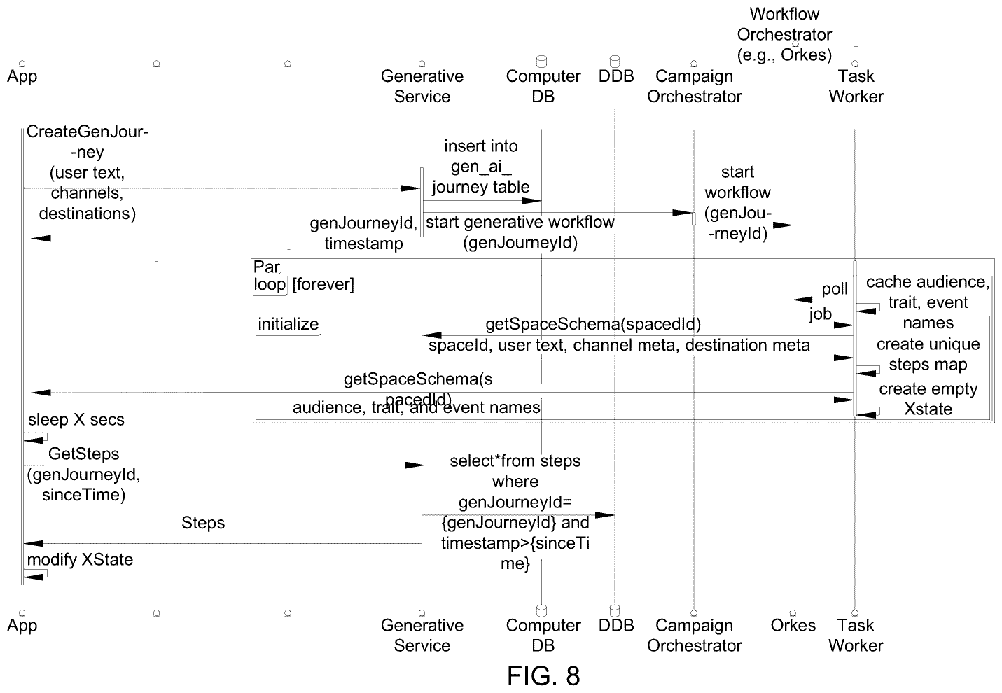

FIG. 8 is a sequence diagram that depicts an example operational flow and interactions among various components within the Generative Journeys system, specifically focusing on the creation and polling of generative journeys. This diagram depicts the dynamic processes that facilitate the generation, validation, and management of personalized customer journeys.

The sequence begins with the App, where users initiate the creation of a generative journey. Users input specific criteria and configurations for the journey. In example embodiments, the inputs then sent to the Gateway API, which functions as an interface for incoming requests, efficiently routing these requests to the appropriate backend services.

Upon receiving the journey creation request, the Generative AI Service acts as the first point of backend interaction. It processes the request to ensure that all necessary data is correctly formatted. The Generative AI Service interfaces with AI models to dynamically generate the content of the journey based on the input criteria.

The generated journey data, which includes various journey steps and their respective conditions, is then sent back to the Generative AI Service. The Generative AI Service performs an initial validation of these steps to ensure they meet predefined criteria and standards. Once validated, these steps are temporarily stored in the Compute DB, specifically within a table designed to handle the data flow for active generative journeys.

Simultaneously, the Campaign Orchestrator oversees the entire process, ensuring that each component performs its designated function correctly and that data flows smoothly through the system. It coordinates the activities of various components, managing dependencies and orchestrating the overall process to maintain system efficiency and effectiveness.

The Generative Task Workers may play a role in further processing the journey steps. For example, they may perform detailed validations, apply business rules, and ensure that the generated journeys meet all specified requirements. These workers may help maintain the quality and compliance of the generated journeys.

Throughout this process, the App may continuously poll the system to retrieve updates on the journey generation status. This polling is managed through the Gateway API, which queries the Personas Service for the latest journey data stored in the Compute DB. The Personas Service retrieves the requested data, ensuring that the most current and relevant journey information is sent back to the App for user review and further action.

From the initial user input in the App to the final storage and retrieval of journey data in the Compute DB, each component plays a role in delivering personalized and effective customer journey experiences. The use of continuous polling ensures that the system remains responsive and up-to-date, providing users with timely feedback and the ability to dynamically interact with the journey generation process.

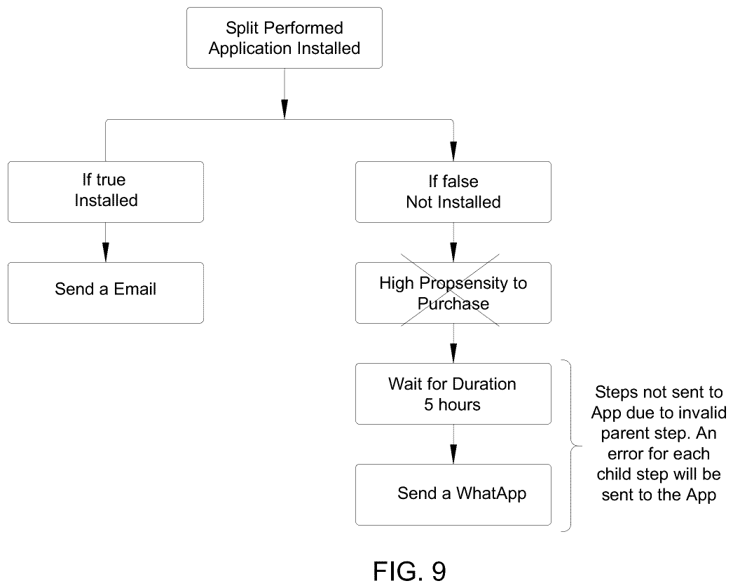

FIG. 9 is flowchart that outlines an example decision-making process within the Generative Journeys system. This diagram depicts examples of conditional logic applied based on user interactions and system checks, which may directly influence the subsequent actions in a customer journey.

The flowchart initiates with a journey that executes journey steps depending on whether an application has been installed for the customer. This node evaluates whether a specific application, necessary for the continuation of the journey, is installed on the user's device. The outcome of this check dictates the path the journey will take:

If True (Installed): The flowchart proceeds along the path labeled “Installed,” indicating that the required application is present. This positive outcome might trigger actions that utilize the application's features to enhance the user's experience or to push the journey towards specific marketing goals. For instance, the system might leverage the application to provide personalized content directly through the app, enhancing user engagement and satisfaction.

If False (Not Installed): Conversely, if the application is not installed, the journey follows the “Not Installed” path. This scenario typically triggers alternative strategies such as prompting the user to install the application or offering other engagement options that do not require the application. This branch ensures that the journey can still provide value and maintain engagement even without the application installed.

Subsequent to these initial decisions, the flowchart introduces another decision node: “High Propensity to Purchase”. This node assesses the likelihood of a purchase based on user behavior or predictive analytics, leading to tailored marketing actions:

If True: The system activates actions like “Send an Email,” targeting users identified as having a high likelihood of making a purchase. This step involves crafting personalized emails with compelling offers or relevant product information, aimed at converting the user's high purchase intent into actual sales.

If False: In cases where the propensity to purchase is low, the journey introduces a delay with “Wait for Duration 5 hours.” This waiting period allows for potential changes in the user's behavior or external factors that might increase purchase likelihood. Post-wait, the journey reassesses the user's status to determine the next best action.

The flowchart also addresses scenarios where certain steps cannot be executed due to issues in preceding steps, labeled as “Steps not sent to App due to invalid parent step.” In such cases, errors for each affected child step are communicated back to the application, ensuring transparency and allowing for corrective measures to be taken.

Moreover, alternative communication methods like “Send a WhatsApp” are depicted, offering flexibility in user engagement through preferred channels. This diversity in communication methods caters to user preferences and optimizes the outreach strategy.

FIG. 9 illustrates how different scenarios based on user interactions and system checks may influence the journey's progression, ensuring that each step is optimally aligned with user needs and system goals. This underscores the system's capability to adapt and respond dynamically, enhancing user engagement and achieving targeted marketing outcomes effectively.

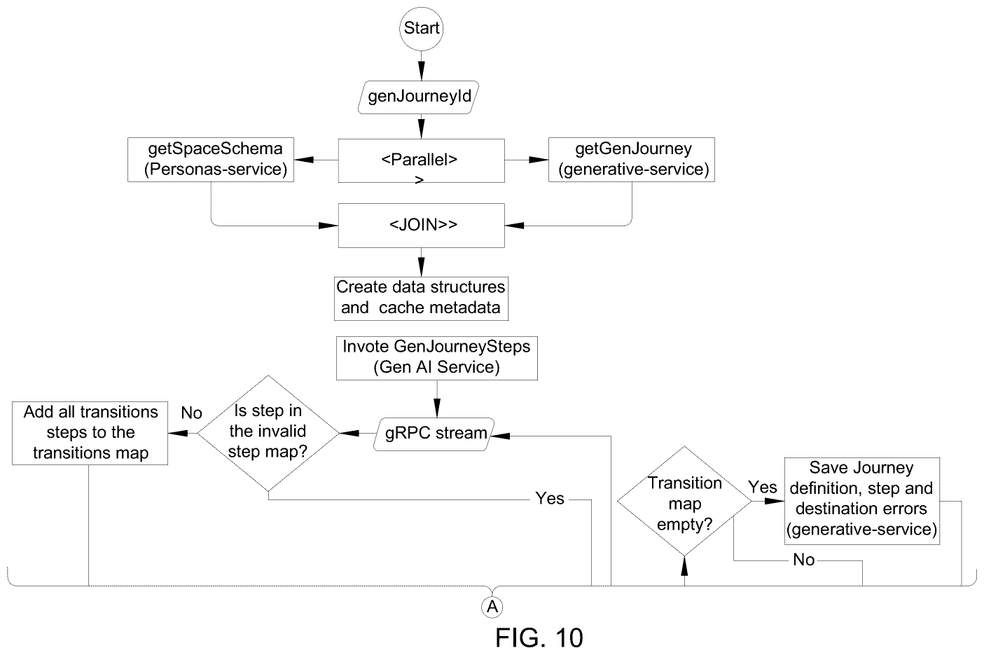

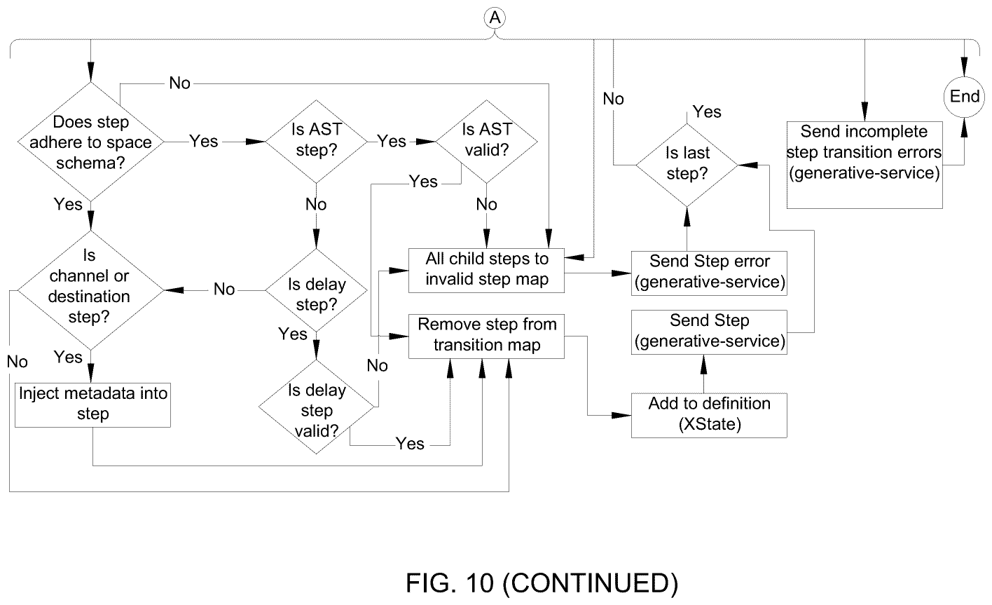

FIG. 10 is sequence diagram that outlines an example operational flow for initiating and processing a generative journey within the Generative Journeys system. This diagram depicts example sequences of actions and interactions among various system components from the start of a journey to the generation of journey steps.

In example embodiments, the sequence begins with the “start” node, which marks the initiation of the generative journey process. This is the point where a user or system-triggered event kicks off the journey creation workflow. Following this initiation, the first major action is the “getJourneyId” operation, which involves retrieving a unique identifier for the new journey. This identifier may link subsequent actions and data to this specific journey instance, ensuring data consistency and traceability throughout the journey's lifecycle.

After obtaining the journey ID, the process moves to a decision-making step involving the Generative Service. The Generative Service first retrieves the necessary journey metadata, which includes user inputs and system parameters that define the journey's scope and objectives. This metadata may be used for configuring the journey correctly and ensuring that it aligns with user expectations and system capabilities.

The retrieved metadata is then passed to the Generative AI Service, which is responsible for the actual generation of the journey steps based on the provided metadata. This service utilizes one or more AI models to dynamically create content that matches the defined criteria, effectively translating abstract user inputs into concrete journey steps that can be executed within the system.

Parallel to the journey step generation, the “getSpaceSchema” (e.g., or “getContextSchema”) operation is executed, which involves fetching the current data schema that defines the structure of data storage and manipulation within the system. This schema may be used for ensuring that the generated journey steps adhere to system data standards and are compatible with other system components.

Once the journey steps are generated, they are subjected to one or more validation checks to ensure their correctness and effectiveness. These validations may include checking the adherence of steps to the context schema, ensuring that the steps are logically and functionally sound, and/or verifying that they meet all specified requirements for successful execution.

The validated journey steps may then compiled into a comprehensive journey definition, which may be stored and managed within the system for execution and tracking. This definition includes one or more details about the journey steps, their sequence, and/or execution conditions, providing a blueprint for how the journey should unfold.

Throughout this process, interactions may occur between different system components, including data exchanges and dependency checks, ensuring that each component contributes effectively to the journey creation process. The depicted interactions highlight the system's capability to handle complex workflows and dynamically generate personalized customer journeys based on diverse inputs and conditions.

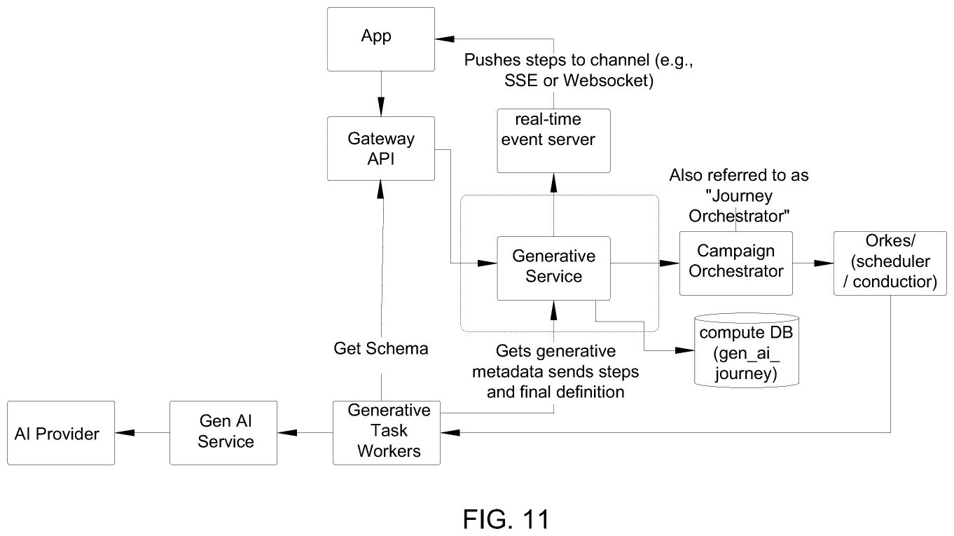

FIG. 11 is a sequence diagram that outlines an example operational flow for managing and executing generative journeys.

The sequence initiates with the App, where users input specific criteria and configurations to create a generative journey. This user input may set one or more parameters for the journey's customization and personalization. The input is transmitted to the Gateway API, which serves as the interface between the user-facing application and the backend services, efficiently routing these inputs to the appropriate services for further action.

Upon receipt of the journey creation request, the Personas Service processes the data to ensure it is correctly formatted and then forwards it to the Generative AI Service. The Generative AI Service uses one or more AI models to dynamically generate the content of the journey based on the input criteria. This involves creating a series of journey steps that are tailored to the user's specifications and the system's capabilities in generating dynamic content.

In parallel, the Campaign Orchestrator, also known as the Orkes (scheduler/conductor), manages the workflow, ensuring smooth data flow and coordination among the system components. It handles dependencies and orchestrates the overall process to maintain the efficiency and effectiveness of the system.

Once the journey steps are generated by the Generative Service, they go through initial validation. After validation, these steps are temporarily stored in the Compute DB. This specialized database is designed to manage the data flow for active generative journeys, supporting the storage of journey definitions and ensuring quick data retrieval and management.

The Generative Task Workers may be involved in further processing the journey steps. They may conduct detailed validations, apply business rules, and ensure that the generated journeys adhere to all specified requirements. These workers may ensure the quality and compliance of the generated journeys.

Throughout this process, the App continuously polls the system to retrieve updates on the journey generation status. This polling is managed through the Gateway API, which queries the Personas Service for the latest journey data stored in the Compute DB. The Personas Service retrieves the requested data, ensuring that the most current and relevant journey information is sent back to the App for user review and further action.

In example embodiments, from the initial user input in the App to the final storage and retrieval of journey data in the Compute DB, each component plays a role in delivering personalized and effective customer journey experiences. The continuous polling mechanism ensures that the system remains responsive and up-to-date, providing users with timely feedback and enabling dynamic interaction with the journey generation process. This underscores the system's capability to handle complex workflows and generate personalized customer journeys based on diverse inputs and conditions.

In example embodiments, the polling mechanism depicted in various example embodiments may be replaced with a more advanced and/or efficient notification system. This modification may optimize system responsiveness and minimize the resource consumption associated with the depicted polling method.

Although various figures depict the App periodically sending requests to the Gateway API to check for updates on the journey generation status, this approach can, under certain circumstances, lead to increased network traffic and higher loads on the server, such as when multiple users or instances engage with the system simultaneously.

As an alternative or additional option, a push-based model may be employed, which is designed to enhance real-time interaction between the server and the App. In example embodiments, instead of the App querying the server at regular intervals, a real-time event server may actively push updates to the App as soon as they are available. This model may leverage modern web communication protocols, such as Server-Sent Events (SSE) or WebSockets, which establish a persistent, open connection between the client and the server for full-duplex communication.

In example embodiments, when the Generative Service completes the generation of journey steps or encounters significant events (such as errors or status changes), it triggers a notification event. The real-time event server then immediately relays this information to the App, ensuring instantaneous delivery of updates without the need for continuous polling. This technique may enhance the user experience by providing immediate feedback and updates, fostering a more interactive and responsive interface.

Furthermore, the notifications may be configured to handle a wide array of events beyond just the completion of journey steps. A notification system can efficiently manage notifications related to system errors, changes in journey configurations, or other relevant actions that affect the user's workflow. This comprehensive approach ensures that all critical information reaches the user promptly, enabling faster decision-making and enhancing overall system usability.

The notification system may not only align with modern web application standards that favor real-time interactions but also significantly reduce the backend load. By eliminating constant polling requests, the server only transmits data when necessary, optimizing resource utilization and improving the system's scalability as user engagement increases.

Thus, while some of the figures described herein illustrate a polling system, it is important to note that alternative embodiments, such as the proposed notification system, can be implemented to leverage the advantages of real-time data delivery and interactive communication. This flexibility in design allows the Generative Journeys system to adapt to evolving technological landscapes and user expectations, ensuring that the platform remains cutting-edge and efficient. Injecting XState Metadata

Channels and destinations may have additional metadata and that is not produced generatively. For example, channels have templates attached to them. This attachment for Gen Journeys will happen post generation where the user has to edit the step and associate with a template. Destinations have Identify calls as default settings which will update a trait on the user's profile. Users can alternatively select Track calls or send mobile IDs.

Exit settings are chosen by the user when building the journey. These are also part of the XState. Currently this is time based, so having the user enter text to produce this generativity would be unnecessary. One example of an advanced setting is for when a specific campaign goal is met.

There are 2 options for injecting destinations, exit and goal setting into XState:
1. Pass it along as JSON snippets to the GenAI Service
2. Inject it at personas-service before storing the generated definition

In option 2, the Task Worker injects this metadata for the following reasons:
Separation of concerns
GenAI responsibilities are for generative content, not stitching together Xstate
If metadata is augmented in any way, it stays local to the Campaigns team where intimate journeys business logic resides

The following subsections discuss the categories of metadata that may be injected.

### Destinations Step Metadata Snippet

Input into GenAI:
Type, destination name, destination id & metadataId

### JavaScript

Everything in green is injected by the Task Worker at the time of validating the step. The Gen AI Service will produce everything in blue.

The meta.name is what is displayed in the UI for the step name. Gen AI will have to produce something relative to the destination name, or utilize the destination name to produce something related.

″sync_x2t0j″: {
″meta″: {
″type″: ″sync″,
″name″: ″destination″,
″destinations″: [{
″id″: ″2qAtR5pZcf1DjG2D9CdUAF″,
″metadataId″: ″55d3d3aea3c″,
″name″: ″Postgres (tommy's heroku pgsql)″,
″logo″:
″https://d3hotuclm6if1r.cloudfront.net/logos/postgres-default.svg″,
″type″: ″warehouse″,
″settings″: {
″send_identify″: true,
″send_track″: false,
″send_mobile_ids″: false,
″audience_entered_event″: ″Audience Entered″,
″audience_exited_event″: ″Audience Exited″,
″id_sync″: { }
}
}]
}
}

### Messaging Step Metadata Snippet

Input into AllGenAI:
GenAI service will be passed a channels object. For Pilot the channel's object will contain only “email”. The Gen AI Service will produce everything in blue below and the Task Worker will inject everything in green. Name below can be set to Email send. The UI component will handle the nullability of the unassociated template.

″email_a79kv″: {
″meta″: {
″name″: ″test″,
″id″: ″ema_2RI6yZgx2tPgKjnBzkCl3ePhyMv″,
″bcc″: [ ],
″body″: ″<some html″>,
″type″: ″email″,
″subject″: ″test″,
″bodyType″: ″html″,
″fromName″: ″test″
″fromEmail″: ″pat@segmenttestmail.com″,
″fromDomain″: ″segmenttestmail.com″,
″previewText″: ″″,
″replyToName″: ″test″,
″fromUsername″: ″pat″,
″replyToEmail″: ″pat@segmenttestmail.com″,
″replyToEqualsFrom″: true
},
″on″: {
″sync_x2t0j″: {
″target″: ″sync_x2t0j″
}
}
}

### Exit Settings

Exit settings may be injected by the Task Worker at the time of writing the generative definition.

### Example

″exitSettings″: {
″exitConditions″: [ ],
JavaScript
JavaScript
″reentryCondition″: {
″type″: ″none″
}

### Example User Interfaces

The following figures include example screens of an example user interface for the system.

FIG. 12 is a screenshot of a dashboard user interface for managing journeys. Created journeys (all, published, drafts, or archived) are listed along with their status, destinations, channels, and meta data (e.g., when they were last modified). They can be deleted, sorted, or arranged, and searched.

In example embodiments, the dashboard interface may be used for managing all journeys that have been created. This centralized workspace allows marketers to visually track and control journeys across their lifecycle. The main content area contains a tabular view listing out journeys, with each journey mapped to a row. Useful metadata columns are displayed, including the journey name, current status (such as draft or published), configured destinations and channels for the journey, and the last modified timestamp.

A robust set of controls allows sorting, searching, arranging, and taking bulk actions on sets of journeys. Common actions like deleting, archiving or duplicating can be quickly performed from this interface. The sidebar contains navigation links to access other areas of the marketing workspace, allowing easy movement between related tools.

In example embodiments, this dashboard is the central hub from which marketers can visually monitor all journeys across various states, while enabling bulk administrative actions as required. The tabular presentation coupled with rich metadata, sorting and controls empowers marketers to manage journeys effectively all from a single view. This enhances visibility and control for marketers when leveraging journeys powered by generative AI capabilities.

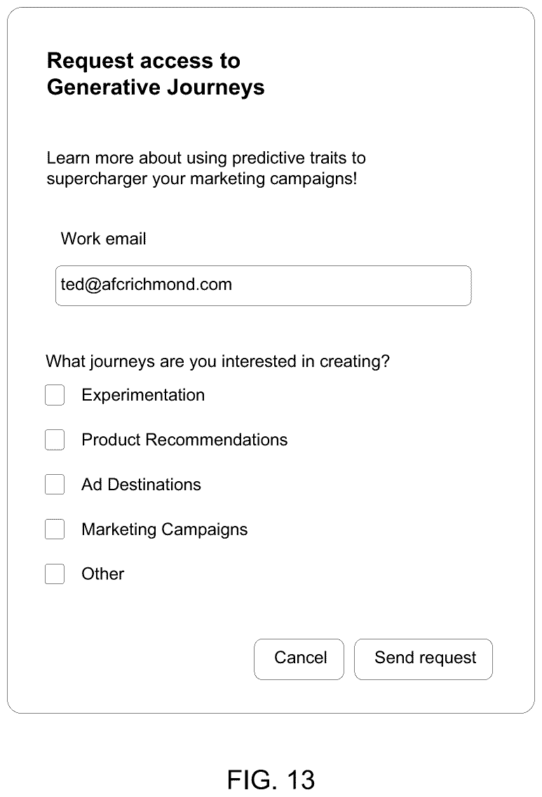

FIG. 13 is a screenshot of an example access user interface. In example embodiments, depending on access rights and/or privileges, access is first requested by a user before it may be subsequently granted by an administrator.

The form first collects the user's work email address, which allows the request to be appropriately routed. Next, it requests details on what types of journeys the user is interested in creating. Multiple interest areas can be selected from common journey use cases like experimentation, product recommendations, marketing campaigns etc. An open-ended “Other” field also allows specifying custom journey types not covered in the provided options.

Once the form is submitted, the access request is sent to administrators for review and approval. By requiring this permission flow before Generative Journey access is granted, the system maintains oversight and governance over who can leverage the AI capabilities. The informative text and structured request form allows collecting purpose and context to inform the approval decision.

In example embodiments, this interface enables a governed access process for Generative Journeys tailored to different user needs. The layered text, input form and review workflow ensures users understand the offering and administrators make informed access decisions. This balances wide access with oversight when providing AI functionality.

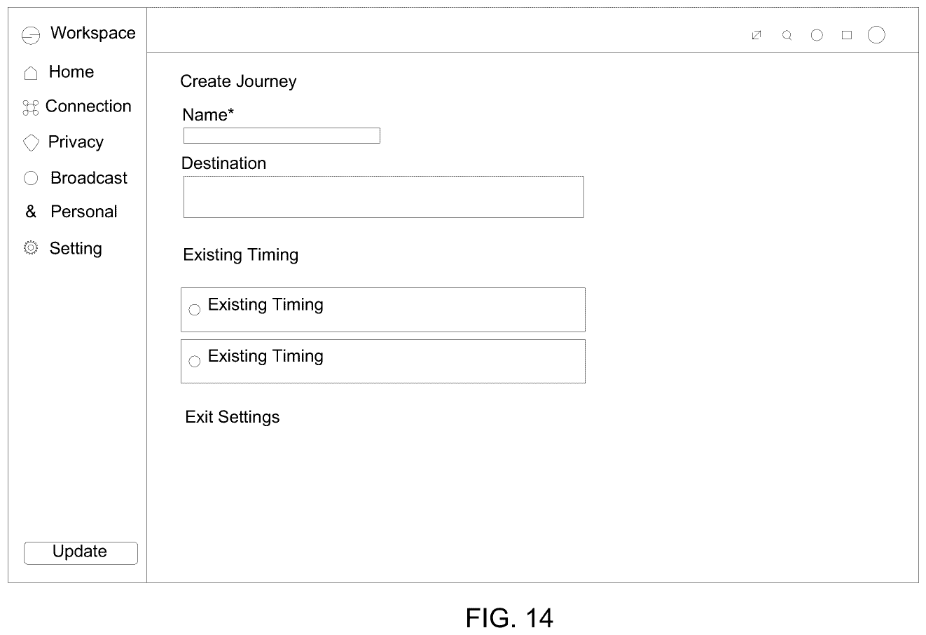

FIG. 14 is a screenshot of an example Journey creation user interface. In example embodiments, the user interface includes fields for specifying a name of the journey, a description of the journey, entry settings (e.g., single entry or multiple entry, and/or exit settings.

In example embodiment, this is the starting point for marketers once they have been granted access through the workflow shown in FIG. 8.

The interface has a clean and simple layout focused just on the key inputs needed to kick off journey generation using AI. The top section allows giving the journey a name and description. The middle section contains settings to configure both entry and exit criteria for the journey-including options like single vs multiple entry, and specifying on-demand or automated exit rules.

The bottom of the interface contains the action to trigger the generation process. When clicked, this will construct the AI prompt consisting of the provided metadata and user-entered objective text. It passes this to the model to output the initial journey definition draft.

By streamlining down to just the essential configurability like name, description, entry/exit settings, the interface minimizes complexity for marketers. The generation trigger clearly signifies the next step to hand over control to the AI for drafting the foundational journey definition. All additional complexity is handled behind the scenes.

In example embodiments, this interface focuses the initial journey creation interface on simplicity and clarity. Just the key metadata, parameters and action trigger to enable anyone to leverage Generative Journeys with no technical expertise required. This makes sophisticated AI journey mapping accessible within a few clicks.

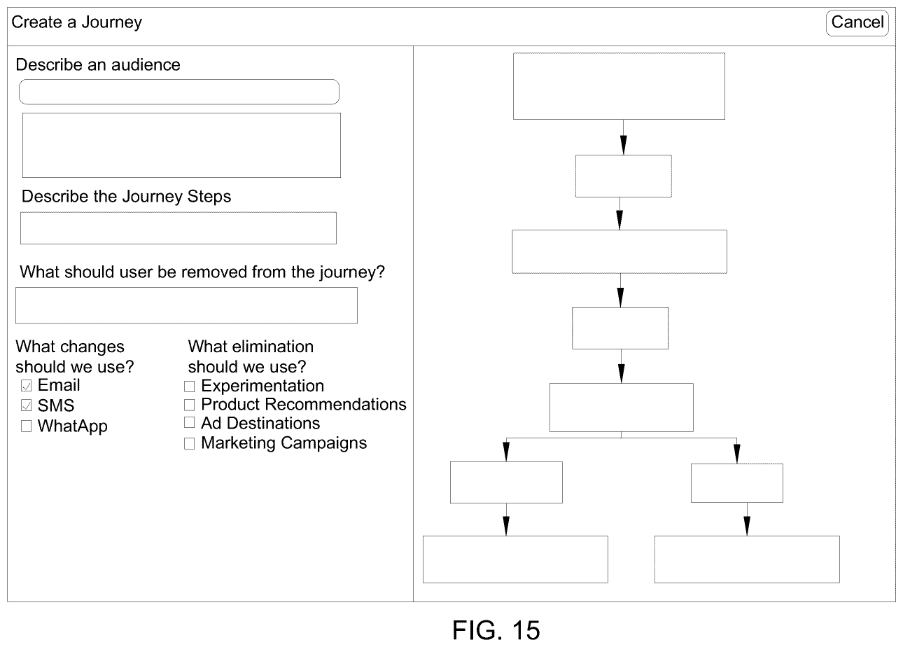

FIG. 15 is a screenshot of an example journey editor user interface. Each node of the journey may be connected to one or more other nodes (e.g., via drag and/or drop or natural language commands). For example, a description of the journey steps may be entered (e.g., in natural language), interpreted (e.g., by an LLM), and applied to the journey flow. Additionally, information pertaining to when users should be removed from the journey may be specified (e.g., in natural language) and interpreted (e.g., by an LLM) and applied to the journey nodes. Additionally, channels may be specified (e.g., email, SMS, and/or WhatsApp) and/or destinations may be specified (e.g., Customer, Braze, Zendesk, and/or Salesforce).

FIG. 10 shows the journey editor interface where marketers can customize the AI-generated journey draft. This builds on the initial definition created in FIG. 9 by allowing granular refinements in a visual, drag-and-drop canvas.

The editor organizes journey construction into clear stages-describing the audience, detailing multi-step interactions, removing users, selecting channels and configuring destinations. Structured templates guide the user through each stage.

The audience section allows marketers to describe the exact target cohort in natural language. The AI will parse this to construct a technical audience definition leveraging available profile and event data. Any errors will be highlighted for the user to refine the description.

A key section is describing the journey steps, depicted visually in the editor canvas. Marketers simply outline a narrative sequence and the underlying AI will handle translating this to technical definitions and logic. Errors are again highlighted with guidance to rephrase descriptions that cannot be mapped to executable definitions.

Additional stages allow specifying user exit criteria, preferred messaging channels and destinations to orchestrate engagements across. Structured inputs like checkboxes guide selection, while leaving room for custom options.

In example embodiments, the user interface provides a structured journey editor canvas to visually customize the AI-generated definition. Guided templates for each stage of the journey construction empowers marketers to describe consumer engagements in plain language. The AI handles accurately translating this to technical, executable definitions that can be activated across channels.

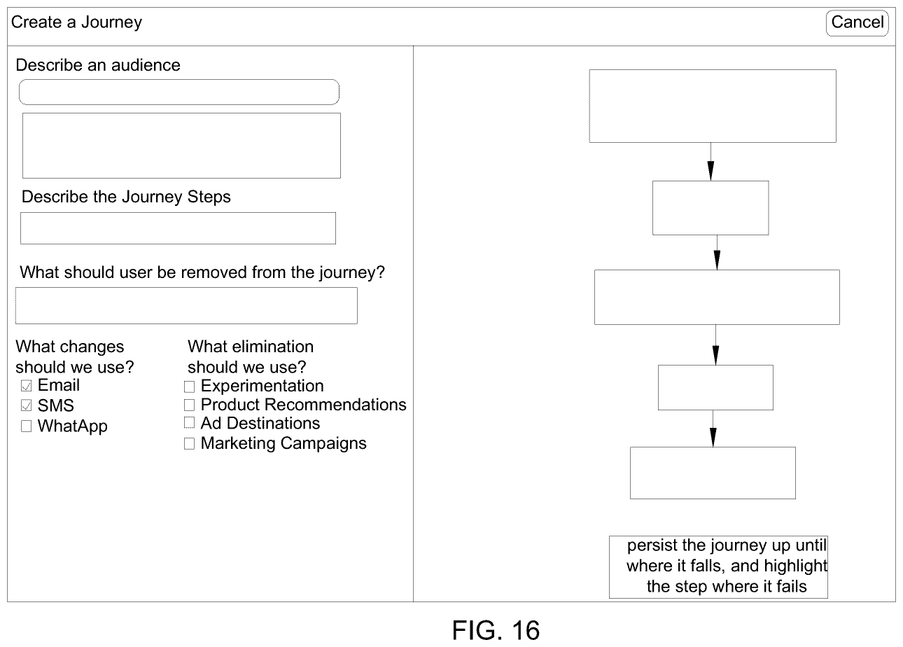

FIG. 16 is a screenshot of a user interface for editing a journey flow using a natural language command within the example journey editor. Here, the instruction “persist the journey up until where it fails, and highlight the step where if fails” is implemented within the Journey editor (e.g., based on LLM queries and responses).

FIG. 11 showcases an advanced capability allowing users to modify the generated journey logic through natural language instructions. This building on top of the core visual journey editor depicted in FIG. 10.

The interface displays the familiar drag-and-drop journey canvas where each box denotes a specific user interaction along the path. To modify the underlying logic, the user simply edits the text in the bottom text box to add natural language instructions.

As shown, an example instruction is provided: “Persist the journey up until where it fails, and highlight the step where it fails”. This expresses the desired change in plain unambiguous terms. The underlying AI model will interpret this, locate the appropriate place to apply the change in the journey logic, and handle translating the instruction into technically executable definitions.

Once processed, the journey map updates visually to reflect the new logic. The specific step where failures will now persist is highlighted for the user. By enabling complex logic changes through intuitive natural language edits, this capability greatly reduces the technical expertise needed to customize sophisticated journey logic powered by AI.

In example embodiments, this interface demonstrates a key interaction paradigm that builds on the visual journey map editor. Allowing users to modify the generated definition by simply expressing logic changes in plain language. This provides wide access for non-technical users to customize advanced journey logic without needing to manipulate technical implementations themselves.

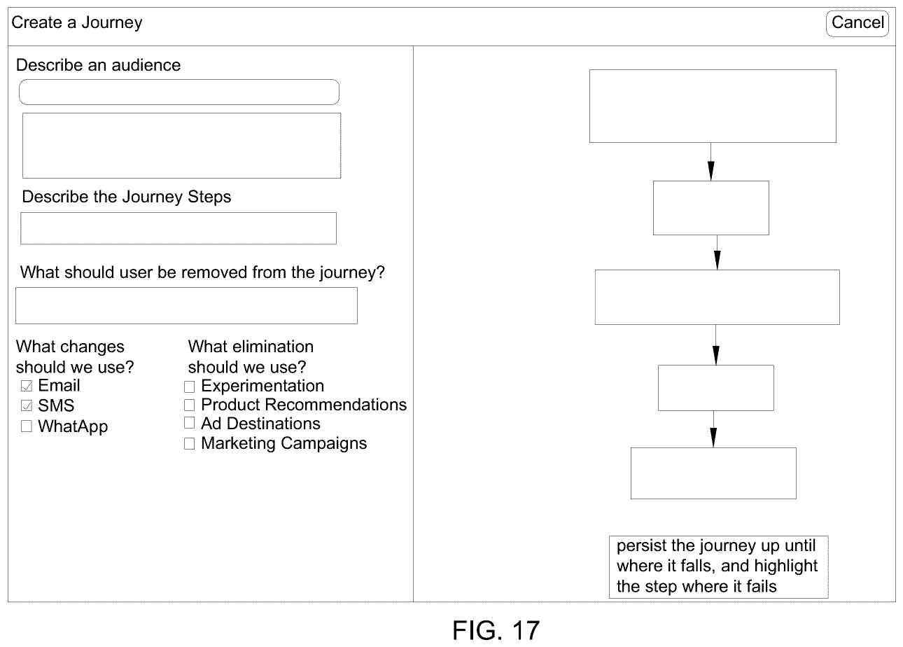

FIG. 17 is a screenshot of a user interface for editing a journey flow that includes a field for describing an audience using natural language.

In example embodiments, the depicted user interface is an enhanced interface for describing the audience that will enter the journey being designed in the generative editor. This builds on FIG. 10 by providing more guided templates and visual feedback to assist the user in accurately specifying their target cohort.

The top of the interface contains a text box for the user to comprehensively delineate the audience definition in plain language. Helpful placeholder text provides examples of potential demographic, behavioral and predictive traits that can be used to qualify the audience. As the description is typed, the background color remains red until the system is able to successfully parse the text into a valid audience schema.

Once a technically valid description is registered, the text box background turns green. Additionally, an embedded graph visualization appears showing the relative size of the qualified audience out of all customers. This helps the user understand how inclusive or narrow their described cohort is based on provided traits.

If an invalid or incomprehensible audience is entered, the text box turns red again and an error message prompts the user to rephrase their description. This real-time feedback loop empowers non-technical users to iterate quickly on their audience definition using natural language, guided by visual confirmations when a valid schema has been interpreted.

In example embodiments, this interfaces enhances the audience description capabilities through guided templates, embedded visualization and continuous error handling. This enables intuitive iteration on audience definitions to be seamlessly translated into technically executable cohorts powering tailored customer journeys.

### Example Operations

In example embodiments, as discussed above, the system is configured to perform one or more of the following operations (e.g., to generate a user journey definition using artificial intelligence):
receiving, by the journey generation system, a user text prompt describing a desired user journey objective;
extracting, by the journey generation system, context data for a plurality of users from a customer data platform, the context data comprising customer event data, profile trait data, and/or audience data;
constructing, by the journey generation system, a journey generation prompt comprising the received user text prompt and the extracted context data;
inputting, by the journey generation system, the constructed journey generation prompt into a model;
generating, by the model, a user journey definition responsive to the constructed journey generation prompt;
validating, by the journey generation system, executable logic of the generated user journey definition; and/or
outputting, by the journey generation system, the validated user journey definition to a campaign orchestration system for execution.

In example embodiments, the validating of the executable logic may include one or more of the following operations:
parsing the generated user journey definition or component of the journey definition into a predefined data structure (e.g., an abstract syntax tree (AST) format that represents an audience definition); In example embodiments, an AST may represent a specific type of step within a journey, such as a step related to audience computation or building. Not all steps in a journey are AST steps. For example, steps involving waiting, checking for events, or sending messages are not considered AST steps. The journey definition is broader than just AST and can include various types of steps, of which AST is one component.
analyzing the data structure to determine validity of the generated user journey definition based on predefined journey schema rules; and/or
modifying the generated user journey definition responsive to determining one or more nodes violate the predefined journey schema rules.

In example embodiments, the model comprises a transformer-based natural language model trained on a journey definition dataset.

In example embodiments, the system is configured to further perform one or more of the following operations:
monitoring execution of the outputted user journey definition;
collecting user engagement data and journey performance metrics associated with the executed user journey; and/or
retraining the model based on the collected user engagement data and journey performance metrics.

In example embodiments, the context data comprises at least one of: customer profile attributes, behavioral event data, transaction event data, engagement event data, or predicted trait data.

In example embodiments, generating the user journey definition comprises one or more of the following operations:
generating one or more audience criteria steps for the user journey definition based on the extracted context data;
generating one or more wait steps specifying a duration between user journey steps; and/or
generating one or more message steps comprising selecting message templates for delivery over one or more channels.

In example embodiments, validating of the generating user journey definition further comprises determining whether the generated journey definition is compliant with one or more regulatory policies.

In example embodiments, the operations map sequentially to key components outlined in the overall system architecture diagram. This demonstrates how the technical design provides specialized services to enable each stage of the generative journey creation workflow driven by AI.

Operations for journey generation using AI may include:

Receiving a user text prompt—This refers to the plain language description of the desired journey objective provided by the user. It aligns with the architecture component of the Gateway API which serves as the interface for receiving user inputs.

Extracting context data-Refers to pulling relevant event, audience and profile data from the customer data platform to inform journey creation. This leverages the audience and event data services shown in the architecture.

Constructing a journey generation prompt—Combines the user prompt and context to create the input passed to the AI model. This is handled by a component like the Generative AI Service in the architecture.

Generating a journey definition—The model produces a complete journey definition responding to the constructed prompt. This model and inference functionality is provided by the Generative Service.

Validating the journey logic—Created definitions are validated against schema rules and context data integrity. This is enabled through the data structure validation and Compute interfaces in the architecture.

Outputting the journey—Valid journeys are outputted to systems like Campaign Orchestrator for activation. Aligns with deployment flow shown in architecture.

In example embodiments, the system is configured to generate personalized customer journeys through a streaming approach, which represents a significant advancement over previous methods.

This streaming generation process allows for the real-time creation and display of journey steps on the user interface, providing immediate feedback and enabling more dynamic and interactive journey creation.

The system employs a novel workflow where each emitted step is a complete step in a state machine that undergoes validation.

This approach ensures that each step is not only generated but also validated in real-time, allowing for immediate error detection and correction. The journey definition is built incrementally, with each step being validated and appended dynamically to create a growing journey definition.

A key aspect of this invention is the ability to build portions of journey definitions through separate prompts.

This feature allows for the creation of complex journeys by breaking them down into manageable pieces. Users can input natural language descriptions for different parts of the journey, and the system will generate and integrate these portions into a cohesive whole.

The system incorporates a sophisticated validation process that ensures the generated steps adhere to predefined data schema rules and business logic. This includes checking for the existence of events, traits, and audiences within the customer's context or space, as well as validating that the definition is parseable and valid.

Another feature is the system's ability to handle errors and invalid steps. When a step is found to be invalid or there's an error, the system can make decisions on how to proceed. For example, it can choose to return these steps as error steps, allowing users to see broken or missing steps and potentially modify them on a canvas.

The invention also includes a robust notification system that can replace or supplement the polling mechanism. This system employs technologies such as Server-Sent Events (SSE) or WebSockets to push updates directly to client applications, enhancing real-time responsiveness and reducing server load.

Furthermore, the system incorporates a unique approach to context data management. It uses various weighting or recently used algorithms to generate a smaller, more relevant list of context data (such as events, traits, and/or audiences) to feed into the AI model's prompt. This ensures that the generated journeys are highly personalized and relevant to the specific customer context.

Lastly, the invention includes a feature for extending journeys piecemeal. Users can click on a specific step in the journey to expand it, triggering another text prompt that allows for the generation of a subtree under that step. This user-friendly approach enables the creation of complex, multi-step journeys without requiring users to input extensive text descriptions all at once.

In example embodiments, the system receives a user text prompt describing a desired user journey objective (e.g., via an API or through a user interface, such as the journey creation interface described herein). This prompt is then processed (e.g., by the Generative Service) to construct a journey generation prompt by combining the received user text prompt with extracted context data for a plurality of users from a customer data platform.

The context data extraction process involves retrieving relevant behavioral, demographic, and/or predictive data from an integrated Customer Data Platform (CDP).

This data may include customer profile attributes, behavioral event data, transaction event data, engagement event data, predicted next purchase data, and/or audience membership data. To optimize the relevance and efficiency of the context data, the system may employ various weighting or recently used algorithms to generate a smaller, more relevant list of context data to feed into the AI model's prompt.

The constructed journey generation prompt is then input into a machine learning model (e.g., a large language model (LLM)), to produce a user journey definition.

This process may be handled by the Generative AI Service, which interfaces with AI providers to dynamically generate the content of the journey based on the input criteria. The generated user journey definition comprises a plurality of nodes representing one or more journey steps.

In example embodiments, the system uses a streaming approach to journey generation. For example, instead of generating the entire journey definition in one operation, the system produces and processes individual steps in real-time.

This may be achieved through a stream between the Generative AI Service and the Generative Task Workers. Each emitted step is a complete step in a state machine that undergoes immediate validation.

The Generative Task Workers may play a role in processing and validating the generated steps.

They may perform detailed validations, apply business rules, and/or ensure that the generated journeys meet all specified requirements. This includes checking for the existence of events, traits, and audiences within the customer's context or space, as well as validating that the definition is parseable and valid.

If any nodes in the produced user journey definition do not conform with a set of predefined schema rules, the system may modify those nodes.

This modification process may involve parsing the produced user journey definition into a data structure having a predefined format, such as an abstract syntax tree (AST). The system then traverses this data structure to identify nodes violating the predefined schema rules and regenerates these non-conforming nodes.

Throughout this process, the system may employ a robust notification system that can replace or supplement the polling mechanism.

For example, the system may use technologies such as Server-Sent Events (SSE) or WebSockets to push updates directly to client applications, enhancing real-time responsiveness and reducing server load.

Once the journey definition is fully generated and validated, it may be output to a campaign orchestration system for execution.

This may involve storing the journey definition in the Compute DB, from where it can be retrieved and executed by the Campaign Orchestrator.

The system also supports the creation of complex journeys through a piecemeal approach.

Users can extend existing journeys by clicking on a specific step in a user interface, which triggers another text prompt allowing for the generation of a subtree under that step. This feature enables the creation of sophisticated, multi-step journeys without requiring users to input extensive text descriptions all at once.

Furthermore, the system is designed to handle errors and invalid steps effectively.

When a step is found to be invalid or there's an error, the system can make decisions on how to proceed, such as returning these steps as error steps or highlighting them on the user interface. This allows users to see broken or missing steps and potentially modify them on a canvas.

By incorporating the described features and processes, the system provides a comprehensive solution for generating personalized, optimized user journeys leveraging artificial intelligence, addressing the technological problems of efficiency, scalability, error handling, and personalization inherent in traditional journey creation approaches.

Execution of the journey definition by the campaign orchestrator may involve a systematic implementation and management of the personalized customer journey across various touchpoints and channels. The campaign orchestrator may act as the central coordination system that brings the generated journey definition to life.

When executing a journey, the campaign orchestrator retrieves the validated journey definition from the Compute DB.

It then begins to process each step of the journey sequentially, taking into account the defined logic, conditions, and triggers.

For example, the orchestrator might start by evaluating the entry conditions for the journey. This could involve checking if a customer meets specific criteria, such as being part of a particular audience segment or having performed a certain action.

Once a customer qualifies for the journey, the orchestrator moves them through the defined steps.

Each step in the journey could represent different types of actions or decision points. For instance:

1. Sending a personalized email: The orchestrator would trigger the email system to send a tailored message based on the customer's profile and journey context.

2. Waiting for a specified duration: The orchestrator might pause the journey for a set time period before moving to the next step, allowing for time-based triggers.

3. Evaluating a condition: The orchestrator could check if a customer has taken a specific action, such as opening an email or making a purchase, and route them to different branches of the journey based on this evaluation.

4. Updating customer data: The orchestrator might trigger updates to the customer's profile in the CDP based on their progression through the journey.

5. Triggering cross-channel interactions: Depending on the journey definition, the orchestrator could initiate actions across various channels, such as sending an SMS after an email, or triggering a push notification based on app usage.

Throughout the execution, the campaign orchestrator continuously monitors the journey's performance, collecting engagement data and metrics. This data is fed back into the system, potentially triggering real-time optimizations or informing future journey generations.

The orchestrator also handles error scenarios and edge cases. For example, if a step in the journey becomes invalid due to changes in the customer's context, the orchestrator might need to re-route the customer or trigger a journey update.

By managing these complex interactions and decision points, the campaign orchestrator ensures that each customer experiences a personalized, responsive journey that adapts to their behavior and context in real-time.

The system's ability to handle complex, multi-step journeys through a piecemeal approach includes allowing users to extend existing journeys by interacting with specific steps on the journey canvas (e.g., a user interface). When a user clicks on a particular step, the system triggers a new text prompt, enabling the generation of a subtree or additional steps under the selected node. This interactive and incremental approach to journey creation addresses the challenge of designing intricate customer experiences without requiring users to input extensive text descriptions all at once. It provides a more intuitive and manageable way to build sophisticated journeys, especially for non-technical users.

The system includes advanced error handling and validation mechanisms. The Generative Task Workers play a role in this process, conducting detailed validations and applying business rules to ensure the generated journeys adhere to all specified requirements. When a step is found to be invalid or an error is detected, the system makes intelligent decisions on how to proceed. For instance, it may return these steps as error steps or highlight them directly on the journey canvas, allowing users to visualize and address issues in real-time. This approach not only enhances the accuracy and reliability of the generated journeys but also provides immediate feedback to users, enabling quick corrections and adjustments.

The use of various weighting or recently used algorithms to generate a smaller, more relevant list of context data (such as events, traits, and audiences) for the AI model's prompt is a significant innovation. This feature ensures that the generated journeys are highly personalized and relevant to the specific customer context, while also optimizing the system's performance by reducing the volume of data processed. The ability to efficiently handle and prioritize vast amounts of customer data addresses a key challenge in creating truly personalized customer experiences at scale.

Furthermore, the system can replace or supplement a polling mechanism, employing technologies such as Server-Sent Events (SSE) or WebSockets to push updates directly to client applications. By establishing a persistent, open connection between the client and the server for full-duplex communication, this feature significantly enhances the system's real-time responsiveness. It not only improves the user experience by providing immediate feedback and updates but also optimizes resource utilization by reducing unnecessary network traffic and server load associated with constant polling.

### Example Mobile Device

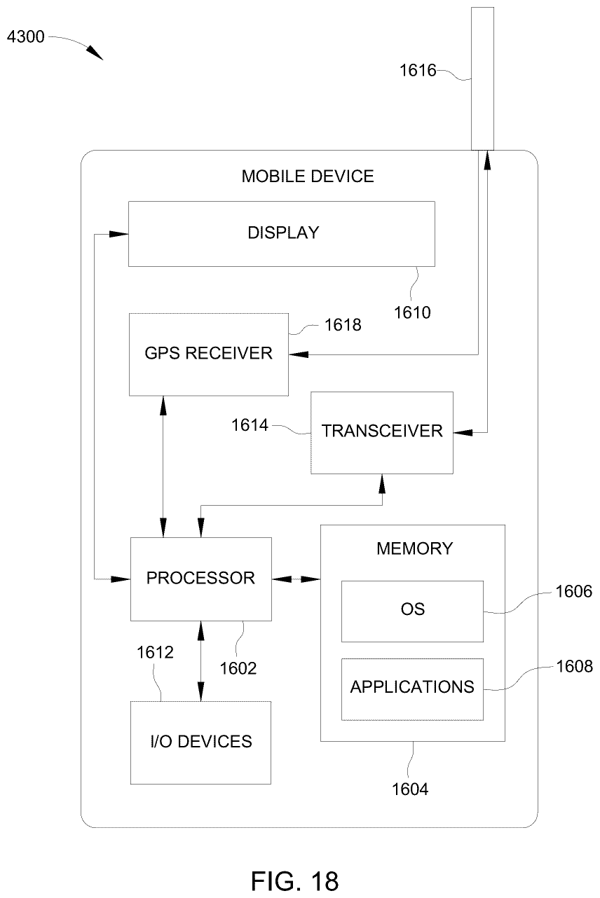

FIG. 18 is a block diagram illustrating a mobile device 4300, according to an example embodiment.

The mobile device 4300 can include a processor 1602. The processor 1602 can be any of a variety of different types of commercially available processors suitable for mobile devices 4300 (for example, an XScale architecture microprocessor, a Microprocessor without Interlocked Pipeline Stages (MIPS) architecture processor, or another type of processor). A memory 1604, such as a random access memory (RAM), a Flash memory, or other type of memory, is typically accessible to the processor 1602. The memory 1604 can be adapted to store an operating system (OS) 1606, as well as application programs 1608, such as a mobile location-enabled application that can provide location-based services (LBSs) to a user. The processor 1602 can be coupled, either directly or via appropriate intermediary hardware, to a display 1610 and to one or more input/output (I/O) devices 1612, such as a keypad, a touch panel sensor, a microphone, and the like. Similarly, in some embodiments, the processor 1602 can be coupled to a transceiver 1614 that interfaces with an antenna 1616. The transceiver 1614 can be configured to both transmit and receive cellular network signals, wireless data signals, or other types of signals via the antenna 1616, depending on the nature of the mobile device 4300. Further, in some configurations, a GPS receiver 1618 can also make use of the antenna 1616 to receive GPS signals.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).) ELECTRONIC APPARATUS AND SYSTEM

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

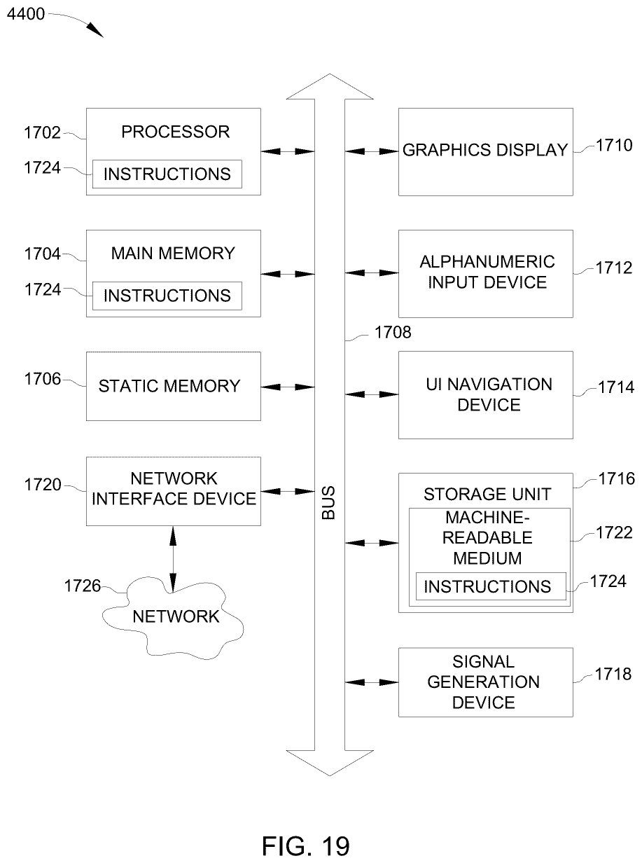

FIG. 19 is a block diagram of an example computer system 4400 on which methodologies and operations described herein may be executed, in accordance with an example embodiment.

In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 4400 includes a processor 1702 (e.g., a central processing unit (CPU), a graphics processing unit (GPU) or both), a main memory 1704 and a static memory 1706, which communicate with each other via a bus 1708. The computer system 4400 may further include a graphics display unit 1710 (e.g., a liquid crystal display (LCD) or a cathode ray tube (CRT)). The computer system 4400 also includes an alphanumeric input device 1712 (e.g., a keyboard or a touch-sensitive display screen), a user interface (UI) navigation device 1714 (e.g., a mouse), a storage unit 1716, a signal generation device 1718 (e.g., a speaker) and a network interface device 1720.

### Machine-Readable Medium

The storage unit 1716 includes a machine-readable medium 1722 on which is stored one or more sets of instructions and data structures (e.g., software) 1724 embodying or utilized by any one or more of the methodologies or functions described herein. The instructions 1724 may also reside, completely or at least partially, within the main memory 1704 and/or within the processor 1702 during execution thereof by the computer system 4400, the main memory 1704 and the processor 1702 also constituting machine-readable media.

While the machine-readable medium 1722 is shown in an example embodiment to be a single medium, the term “machine-readable medium” may include a single medium or multiple media (e.g., a centralized or distributed database, and/or associated caches and servers) that store the one or more instructions 1724 or data structures. The term “machine-readable medium” shall also be taken to include any tangible medium that is capable of storing, encoding or carrying instructions (e.g., instructions 1724) for execution by the machine and that cause the machine to perform any one or more of the methodologies of the present disclosure, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 1724 may further be transmitted or received over a communications network 1726 using a transmission medium. The instructions 1724 may be transmitted using the network interface device 1720 and any one of a number of well-known transfer protocols (e.g., HTTP). Examples of communication networks include a local area network (“LAN”), a wide area network (“WAN”), the Internet, mobile telephone networks, Plain Old Telephone Service (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A system comprising:
one or more computer processors;
one or more computer memories;
a set of instructions stored in the one or more computer memories, the set of instructions configuring the one or more computer processors to perform operations, the operations comprising:
receiving a user text prompt describing a desired user journey objective;
constructing a journey generation prompt comprising the received user text prompt and extracted context data for a plurality of users from a customer data platform;
inputting the constructed journey generation prompt into a machine learning model to produce a user journey definition comprising a plurality of nodes representing one or more journey steps;
modifying a set of the plurality of nodes in the produced user journey definition to conform with a set of predefined schema rules; and
outputting the user journey definition to a campaign orchestration system for execution.

2. The system of claim 1, wherein the modifying of the set of the plurality of nodes comprises:
parsing the produced user journey definition into a data structure having a predefined format;
traversing the data structure to identify a set of nodes violating the set of predefined schema rules; and
regenerating the set of nodes violating the set of predefined schema rules.

3. The system of claim 1, wherein the machine learning model comprises a transformer-based natural language model trained on a journey definition dataset.

4. The system of claim 1, the operations further comprising monitoring execution of the outputted user journey definition.

5. The system of claim 1, wherein the context data comprises at least one of customer profile attributes, behavioral event data, transaction event data, engagement event data, predicted next purchase data, or audience membership data.

6. The system of claim 1, wherein the generating of the user journey definition comprises:
generating one or more audience criteria steps personalized based on extracted context data;
generating one or more message steps comprising selected message templates for different channels; and
generating one or more wait steps between the one or more message steps.

7. The system of claim 1, the operations further comprising:
collecting user engagement data during execution of the outputted journey; and
retraining the machine learning model based on the collected user engagement data.

8. A method comprising:
receiving a user text prompt describing a desired user journey objective;
constructing a journey generation prompt comprising the received user text prompt and extracted context data for a plurality of users from a customer data platform;
inputting the constructed journey generation prompt into a machine learning model to produce a user journey definition comprising a plurality of nodes representing one or more journey steps;
modifying a set of the plurality of nodes in the produced user journey definition to conform with a set of predefined schema rules; and
outputting the user journey definition to a campaign orchestration system for execution.

9. The method of claim 8, wherein the modifying of the set of the plurality of nodes comprises:
parsing the produced user journey definition into a data structure having a predefined format;
traversing the data structure to identify a set of nodes violating the set of predefined schema rules; and
regenerating the set of nodes violating the set of predefined schema rules.

10. The method of claim 8, wherein the machine learning model comprises a transformer-based natural language model trained on a journey definition dataset.

11. The method of claim 8, further comprising monitoring execution of the outputted user journey definition.

12. The method of claim 8, wherein the context data comprises at least one of customer profile attributes, behavioral event data, transaction event data, engagement event data, predicted next purchase data, or audience membership data.

13. The method of claim 8, wherein the generating of the user journey definition comprises:
generating one or more audience criteria steps personalized based on extracted context data;
generating one or more message steps comprising selected message templates for different channels; and
generating one or more wait steps between the one or more message steps.

14. The method of claim 8, further comprising:
collecting user engagement data during execution of the outputted journey; and
retraining the machine learning model based on the collected user engagement data.

15. A non-transitory computer-readable storage medium storing a set of instructions that, when executed by one or more computer processors, causes the one or more computer processors to perform operations, the operations comprising:
receiving a user text prompt describing a desired user journey objective;
constructing a journey generation prompt comprising the received user text prompt and extracted context data for a plurality of users from a customer data platform;
inputting the constructed journey generation prompt into a machine learning model to produce a user journey definition comprising a plurality of nodes representing one or more journey steps;
modifying a set of the plurality of nodes in the produced user journey definition to conform with a set of predefined schema rules; and
outputting the user journey definition to a campaign orchestration system for execution.

16. The non-transitory computer-readable storage medium of claim 15, wherein the modifying of the set of the plurality of nodes comprises:
parsing the produced user journey definition into a data structure having a predefined format;
traversing the data structure to identify a set of nodes violating the set of predefined schema rules; and
regenerating the set of nodes violating the set of predefined schema rules.

17. The non-transitory computer-readable storage medium of claim 15, wherein the machine learning model comprises a transformer-based natural language model trained on a journey definition dataset.

18. The non-transitory computer-readable storage medium of claim 15, further comprising monitoring execution of the outputted user journey definition.

19. The non-transitory computer-readable storage medium of claim 15, wherein the context data comprises at least one of customer profile attributes, behavioral event data, transaction event data, engagement event data, predicted next purchase data, or audience membership data.

20. The non-transitory computer-readable storage medium of claim 15, wherein the generating of the user journey definition comprises:
generating one or more audience criteria steps personalized based on extracted context data;
generating one or more message steps comprising selected message templates for different channels; and
generating one or more wait steps between the one or more message steps.
